(19) United States
(12) Patent Application Publication
(10) Pub. No.: US 2019/0140562 A1
(43) Pub. Date: May 9, 2019

(54) Rotary Array Assembly

(71) Applicants: Greg HENDERSON, Saratoga, CA (US); Robert MELVIN, Los Gatos, CA (US); Tanner DEVOE, Campbell, CA (US); Arx Pax Labs, Inc., Los Gatos, CA (US)

(72) Inventors: Greg Henderson, Saratoga, CA (US); Robert Melvin, Los Gatos, CA (US); Tanner Devoe, Campbell, CA (US)

(73) Assignee: Arx Pax Labs, Inc., Los Gatos, CA (US)

(21) Appl. No.: 16/099,083

(22) PCT Filed: May 5, 2017
(86) PCT No.: PCT/US17/31375

§ 371 Date: Nov. 5, 2018

Related U.S. Application Data
(60) Provisional application No. 62/332,445, filed on May 5, 2016.

(51) Int. Cl. H02N 15/00; H02K 41/03

(52) U.S. Cl. CPC H02N 15/00; H02K 2201/18; H02K 41/031

(57) ABSTRACT

Electromechanical systems using magnetic fields to induce eddy currents and generate lift and thrust are described. A circumferential array of magnet elements which can be employed in the systems are illustrate. when the circumferential array rotates round its axis, it generates a travelling magnetic field moving along its axis. The travelling magnetic field over a conductive substrate induces eddy currents in the conductive substrate, the eddy currents provide an opposing magnetic field to generate magnetic lift and thrust to support and drive the circumferential array.

### RELATED APPLICATIONS

This application claims priority to PCT Patent Application No. PCT/US17/31375, filed on May 5, 2017 which claims priority to U.S. Provisional Patent Application No. 62/332,445, filed on May 5, 2016 which is specifically incorporated by reference in its entirety herein. This application incorporates by reference the following: U.S. Prov. Appl. No. 61/799,695, filed Mar. 15, 2013; U.S. Prov. Appl. No. 61/977,045, filed Apr. 8, 2014; U.S. Prov. Appl. No. 62/011,011, filed Jun. 11, 2014; U.S. Prov. Appl. No. 62/031,756, filed Jul. 31, 2014; U.S. Prov. Appl. No. 62/066,891, filed Oct. 21, 2014; U.S. application Ser. No. 13/843,914, filed Mar. 15, 2013, now U.S. Pat. No. 8,777,519, issued Jul. 15, 2014; U.S. application Ser. No. 14/069,359, filed Oct. 31, 2013, now U.S. Pat. No. 9,148,077, issued Sep. 29, 2015; PCT Appl. No. PCT/US14/19956, filed Mar. 3, 2014; U.S. application Ser. No. 14/320,327, filed Jun. 30, 2014, now U.S. Pat. No. 9,103,118, issued Aug. 11, 2015; U.S. application Ser. No. 14/639,045, filed Mar. 4, 2015, now U.S. Pat. No. 9,126,487, issued Sep. 8, 2015; U.S. application Ser. No. 14/639,047, filed Mar. 4, 2015, now U.S. Pat. No. 9,263,974, issued Feb. 16, 2016; U.S. application Ser. No. 14/737,442, filed Jun. 11, 2015, now U.S. Pat. No. 9,325,220, issued Apr. 26, 2016; U.S. application Ser. No. 14/792,194, filed Jul. 6, 2015; U.S. application Ser. No. 14/737,444, filed Jun. 11, 2015, now U.S. Pat. No. 9,254,759, issued Feb. 9, 2016; and U.S. application Ser. No. 14/919,537, filed Oct. 21, 2015, now U.S. Pat. No. 9,352,665.

### FIELD

The disclosure relates generally to electromagnetic levitation and propulsion systems. The disclosure relates specifically to devices employing electromagnetic levitation, in particular, to Inductrack and its inherent limitations.

### BACKGROUND

It is already known that if a conductor is disposed with one of its faces confronting an electromagnet energized with alternating current, the electromagnet and the conductor repel one another. It is also known that, with certain configurations for the electromagnets, the electromagnet can be stably supported above such a conductor by this force of repulsion. This is based on Lenz's law, which states that if a magnetic field moves relative to a conductor, an eddy current is generated in that conductor. The alternating current of the electromagnet can generate traveling magnetic wave moving relative to the conductor, an eddy current is generated in the conductor, which generate a magnetic field of their own, mirroring the traveling magnetic wave causing them to repel one another. By focusing this electromagnetic energy downward, they are capable of generating lift.

Magnetic forces including magnetic lift are of interest in mechanical systems to potentially orientate and move objects relative to one another while limiting the physical contact between the objects. One method of generating magnetic lift involves an electromagnetic interaction between moving magnetic fields and induced eddy currents.

An Inductrack halbach array in U.S. Pat. No. 6,629,503 can produce levitating magnetic fields, this fields interact with a close-packed ladder-like array of shorted circuits in a track to generate levitate, once a vehicle using Inductrack linear arrays is pushed and released, it immediately begins to slow due to magnetic drag of induction (the same induction necessary to create the eddy currents in the surface below the array which lift via secondary magnetic fields). As the vehicle slows, the lift force is reduced, and the levitation height drops creating more drag and so on. Lift force, levitation height, and speed all decrease exponentially. This means that a vehicle using Inductrack halbach array would need constant external propulsion thereby defeating its intended purpose. To effectively use external linear induction motors it would mean that they would have to be deployed as a continuous system like commercial maglev systems today at extreme cost.

A hoverboard described in U.S. Pat. No. 9,325,220 is one example of an electromechanical system which generate lift force via an interaction between a moving magnetic field source and induction eddy current, which is incorporated herein by reference. The hoverboard includes a magnetic lifting device and a conductive substrate. The magnetic lifting device is configured to generate a moving magnetic field which induces eddy currents in the conductive substrate. The eddy currents provide an opposing magnetic field, which can be used to generate electromagnetic lift and various translational and rotational force. The moving magnetic field is generated by rotating a disk format permanent magnet array. The axis of the rotation is substantially perpendicular to the plane of the conductive substrate. The movement control of the hoverboard can be effected by tilting the axis of the rotation relative to the conductive substrate. The hoverboard provides a motor to rotate the disk format permanent magnet array and a mechanical structure to tilt the axis of the rotation.

When the axis of the rotation of the disk format permanent magnet array is perpendicular to the plane of the disk format permanent magnet array, the magnetic drag is balanced on all sides of the disk format permanent magnet array, and there is no net translational force resulting from the magnetic drag, the hoverboard will remain in place of over the conductive substrate. In a tilted position, one side of the disk format permanent magnet array is closer to the substrate and the other side of the disk format permanent magnet array is farther away from the substrate, the magnetic interaction between the magnets in the disk format permanent magnet array and the substrate decreases as a distance between the magnets in the disk format permanent magnet array and the substrate increases. Thus, in tilted position, the drag force is imbalance which creates traction and causes a translational force approximately in the direction of the tilted axis of the disk format permanent magnet array.

It has been observed by the invertor herein that direction control works well on the hoverboard and low speed translation, while there exist deficiencies of employing a mechanical structure to tilt the axis of the rotation. For example, the mechanical power distribution is significantly complicated by necessary axis of tilt, typical axes of tilt for control are perpendicular to the direction of needed power distribution from centralized locations for motors, and tilting creates non-parallel axis-of-rotation configuration between the motor and the disk format permanent magnet array. Tilting can produce changes in driveline length and this issue limits valid strategies for mechanical power distribution. The net translational force results from difference of the magnetic drags produced by different section of the hoverboard, a considerable part of the drags acting on the hoverboard balance each other, which lead to poor efficiency of the hoverboard.

Therefore, it would be advantageous to provide new methods and apparatus for generating magnetic lift using eddy current.

### SUMMARY

According to one aspect of the present invention, A circumferential array of magnet elements is provided, the magnetic fields generated by the magnet elements varies in the relative linear/axial, and position/or phase. when the circumferential array rotates round its axis, it generates a travelling magnetic field moving along its axis. In one embodiment, direction angles on different position of the circumferential array are the same. In one embodiment, direction angles on different position of the circumferential array are different. In one embodiment, direction angles in one or a plurality of sections along the axis of the circumferential array are less than 90 degrees, direction angles in other one or a plurality of sections along the axis of the circumferential array are larger than 90 degrees. In one embodiment, direction angles along the circumferential direction of the circumferential array are different. In one embodiment, direction angles in one or a plurality of sections along the circumferential direction of the circumferential array are less than 90 degrees, direction angles in other one or a plurality of sections along the circumferential direction of the circumferential array are larger than 90 degrees. In one embodiment, the circumferential array comprises one or a plurality of linear Halbach array. In one embodiment, the speed of the travelling magnetic field can be adapted by varying the phase increment of the circumferential array. In one embodiment, the speed of the travelling magnetic field can be adapted by varying the wavelength of the travelling magnetic field.

According to other aspect of the present invention, there is provided an electromechanical system using magnetic field to induce eddy current in a conductive substrate and generate lift. The electromechanical system includes a circumferential array of magnet elements and a conductive substrate. The circumferential array is configured to generate a moving magnetic field which induces eddy currents in the conductive substrate. Rotating the circumferential array round its axis will generate a moving magnetic field with regard to the substrate. The eddy currents provide an opposing magnetic field, which generates magnetic lift and thrust to support and drive the circumferential array.

In one embodiment, the axis of rotation is horizontal rather than substantially vertical to the plane of the conductive substrate. The circumferential array can be driven by a motor, such as an electric motor or a combustion engine. The motor can include an onboard power source, such as a battery or tank for holding a combustible fuel. The conductive substrate can include a non-ferromagnetic conductive metal of some type. For example, the conductive substrate can be a thin sheet or lattice work of aluminum or copper.

The electromechanical system can include a platform configured to receive a load. A controller, coupled to the motor, can be configured to control the motor to rotate the circumferential array which causes the circumferential array and the platform to move at a height above the conductive substrate. The circumferential array, the motor, the platform and the controller can be structural linked to one another.

In one embodiment, the circumferential array is composed of a plurality of magnet elements, the magnetic field intensity of which vary in the relative linear/axial position of the circumferential array.

In one embodiment, the circumferential array is composed of a plurality of outward facing, linear Halbach-type magnet elements, which vary in the relative linear/axial position of their array elements. The magnetic position is variable. Successive array elements are exchanged by rotation with regard to their position and interaction with the substrate. This exchange of array with varying relative magnetic position constitutes a moving magnetic field with regard to the substrate.

The changing magnetic field approximates an axial scrolling action, above and into the conductive substrate, with regard to the working magnetic fields.

In one embodiment, the circumferential array comprises a translating linear Halbach-type array that can generate linear thrust aligned with the major axis, which is geometrically neutral with regard to translation along the axis. In one embodiment, the circumferential array comprises an oscillating linear Halbach-type array that can generate linear forward and backward thrust aligned with the major axis. In another embodiment, the circumferential array comprises a linear Halbach-type array that can generate no linear thrust, only lift, if composed of elements which generate opposed thrust aligned with the major axis.

In one embodiment, the Halbach-type array may be adapted to lower and/or higher translation speed by varying the increment and extent of the elements composing the circumferential array.

In one embodiment, the control of the movement of the electromechanical system is based on variations in the RPM of the circumferential array rather than by tilting or mechanically changing the axis of rotation relative to substrate.

According to another aspect of the present invention, there is provided another electromechanical system using magnetic field to induce eddy current in a conductive substrate and generate lift. The electromechanical system includes a magnetic array and a conductive substrate. Generating a moving magnetic field is based on rotating individual magnets each about an axis perpendicular to the magnetization direction through the centroid of each magnet, rather than rotating the array as a whole. The generated moving magnetic field can induce eddy currents in the conductive substrate. The eddy currents provide an opposing magnetic field, which generates magnetic lift and thrust to support and drive the magnetic array.

In one embodiment, varying the rotation rate of the magnets changes the effective velocity of the poles above and below the array; varying the phase angle between adjacent magnets changes the effective wavelength of the array, in turn changing the effective velocity of the poles above and below the array; different phase angles can be used to create Halbach arrays through alternating N-S poles, or any other arbitrary pattern.

In one embodiment, Rotating magnets can be driven independently or in groups. Multiple 1D arrays may be combined to create 2D arrays, with shared or independent drive motors and multiple 1D Arrays may be wrapped in a planetary gear configuration to facilitate motor driving, conducting the flux to the intended surface through ferrous core pieces.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 is an illustration of a linear Halbach array in accordance with the described embodiments;

FIG. 2 is an illustration of a caterpillar in accordance with the described embodiments;

FIG. 3 is a plot of lift associated with an arrangement of rotating magnets as a function of distance from a conductive substrate in accordance with the described embodiments;

FIG. 4 is an illustration of a structure comprising a caterpillar in accordance with the described embodiments;

FIG. 5 is an unfolded view of FIG. 4.

FIG. 6 is an illustration of forming a travelling magnetic field moving from left to right in accordance with the described embodiments;

FIG. 7 is an illustration of forming a travelling magnetic field moving from right to left in accordance with the described embodiments;

FIG. 8 is an illustration of a caterpillar capable of generating unidirectional travelling electromagnetic wave in accordance with the described embodiments;

FIG. 9 is an illustration of a caterpillar capable of generating unidirectional travelling electromagnetic wave in accordance with the described embodiments;

FIG. 10 is an illustration of a caterpillar capable of generating unidirectional travelling electromagnetic wave in accordance with the described embodiments;

FIG. 11 is an illustration of a caterpillar capable of generating oscillation in accordance with the described embodiments;

FIG. 12 is an illustration of a caterpillar capable of generating oscillation in accordance with the described embodiments;

FIG. 13 is an illustration of a caterpillar capable of generating oscillation in accordance with the described embodiments;

FIG. 14 is an illustration of a caterpillar capable of generating bidirectional thrust at the same time in accordance with the described embodiments;

FIG. 15 is an illustration of a caterpillar capable of generating bidirectional thrust at the same time in accordance with the described embodiments;

FIG. 16 is an illustration of caterpillar having MultiRatio in accordance with the described embodiments;

FIG. 17 shows various caterpillars in accordance with the described embodiments;

FIG. 18 shows examples of various electromechanical systems in accordance with the described embodiments;

FIG. 19 shows examples of various electromechanical systems with caterpillars can be assembled to generate magnetic field inward in accordance with the described embodiments;

FIG. 20 shows an electromechanical system including a caterpillar and a conductive substrate in accordance with the described embodiments;

FIG. 21 shows an illustration of a vehicle configured to operate over a conductive substrate in accordance with the described embodiments;

FIG. 22 shows embodiments of various electromechanical systems which can generate relative movement in accordance with the described embodiments;

FIG. 23 is an illustration of a magnet array based on rotating individual magnets in accordance with the described embodiments;

FIG. 24 is an illustration of forming a travelling magnetic field based on rotating individual magnets in accordance with the described embodiments;

FIG. 25 shows magnetic field distribution of magnet arrays which have different angles of magnetization orientation of adjacent magnets in accordance with the described embodiments;

FIG. 26 shows magnetic field distribution of magnet arrays which have different angles of magnetization orientation of adjacent magnets in accordance with the described embodiments;

FIG. 27 shows magnetic field distribution of magnet arrays which have different angles of magnetization orientation of adjacent magnets in accordance with the described embodiments;

FIG. 28 shows a magnetic field distribution of magnet arrays which have patterns varying as a function of position on the arrays in accordance with the described embodiments;

FIG. 29 shows a planetary gear configuration in accordance with the described embodiments.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

With respect to the following figures and sections, electromechanical systems and their operation are described.

The terms “up” and “down”; “upper” and “lower”; “upwardly” and downwardly”; “above” and “below”; and other like terms as used herein refer to relative positions to one another and are not intended to denote a particular direction or spatial orientation.

Linear Halbach Array and Lifting

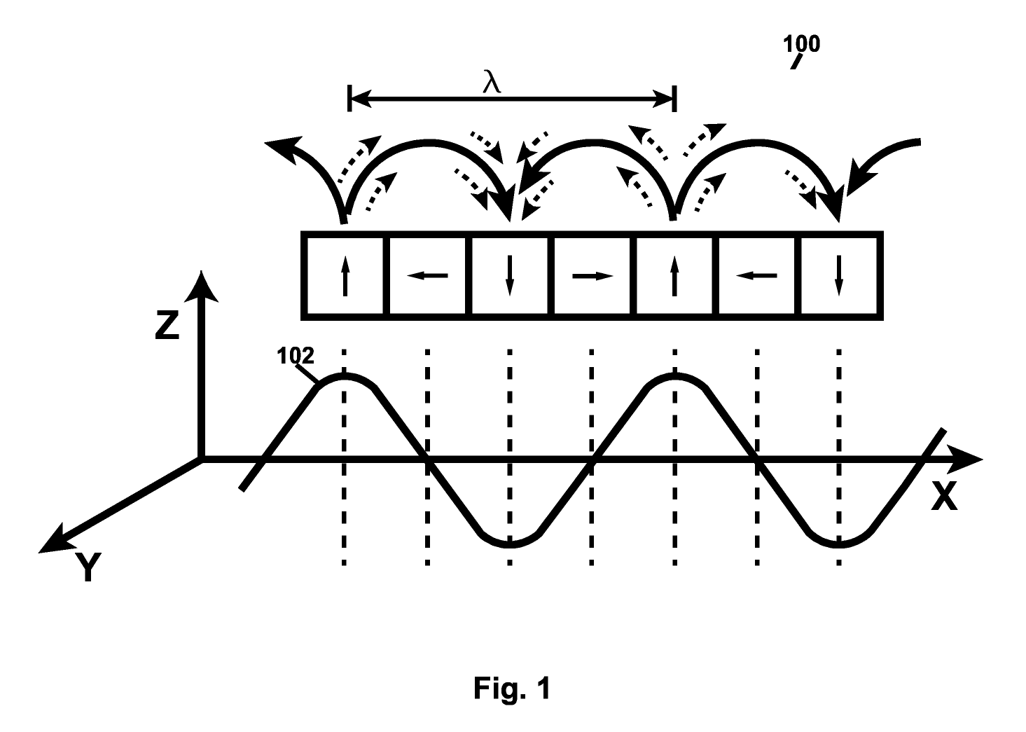

In this section, methods of generating magnetic lift, components used to generate magnetic lift, magnetic lift systems and their operation are described. A Halbach array is a specific arrangement of a series of permanent magnets. The array has a spatially rotating pattern of magnetism which cancels the field on one side, but boosts it on the other. The main advantages of Halbach arrays are that they can produce strong magnetic fields on one side while creating a very small stray field on the opposite side. FIG. 1 is an illustration of a linear Halbach array 100. The linear Halbach array 100 comprises seven pieces of cubic permanent magnets lined along the X-axis. The orientation of each piece's magnetic field is upward, leftward, downward, rightward, upward, leftward and downward from left end to right end of the array. The arrangement of the magnets is cyclical, the rotating angle of the orientation of each piece's magnetic field between adjacent magnets is 90 degrees, one period comprises four pieces of magnets. This kind of arrangement of the magnets give a strong field above the array, while the field underneath would cancel.

Distribution of magnetic field along the X-axis is an approximately sinusoidal waveform 102, the wavelength of the sinusoidal waveform 102 is λ which corresponds to the sum of length of the magnets in a period. The direction of the magnetic field is approximately parallel to the Z-axis and the magnetic field intensities are almost equal along the Y-axis. The axis of the linear Halbach array 100 parallel to the X-axis is referred to as “major axis” of the array, and the axis of the linear Halbach array 100 parallel to the Y-axis is referred to as “minor axis” of the array.

When a “major axis” of a linear Halbach array is parallel to a conductive substrate, and the strong magnetic fields side faces the conductive substrate, if there is relative motion between the array and the substrate, it will generate eddy currents in the substrate.

In various embodiments, a linear Halbach array may has a rotating angle of orientation of each piece's magnetic field between adjacent magnets varying from 0 to 90 degrees. for example, if the rotating angle is 45 degrees, a period of the Halbach array is eight magnets, and the wavelength of the sinusoidal waveform of magnetic field generated by the linear Halbach array is the sum of length of the eight magnets. if the rotating angle is 60 degrees, a period of the Halbach array is six magnets, and the wavelength of the sinusoidal waveform is the sum of length of the six magnets.

A linear Halbach array is Arranged parallel to a conductive substrate, and the strong magnetic field side faces the conductive substrate. The conductive substrate comprises a conductive plate in which eddy currents can be induced. If there is relative motion between the array and the substrate, it will generate eddy currents in the substrate, which generate an opposing magnetic field, the force produced by the two magnetic fields from the array and the substrate can slow the relative motion between them. The force between the array and the substrate is influenced by the direction of the movement of the Halbach array. Especially, when the relative motion is in the direction of the Halbach array's major axis, the largest change of the magnetic field on the conductive substrate is produced, it will generate largest eddy currents in the substrate. The eddy currents and their associate magnetic field and the magnetic fields of the Halbach array interact to generate maximum forces, such as a lifting force and a propulsive force. but at the case that the relative motion is in the direction of the Halbach array's minor axis, magnetic fields are almost equal along the minor axis, it will generate smallest eddy currents in the substrate and the lateral thrust between the array and the substrate appears negligible and there is only lifting force between the array and the substrate.

Next, a few examples of magnet arrangements, which can be used to induce eddy currents in a conductive substrate and generate lift.

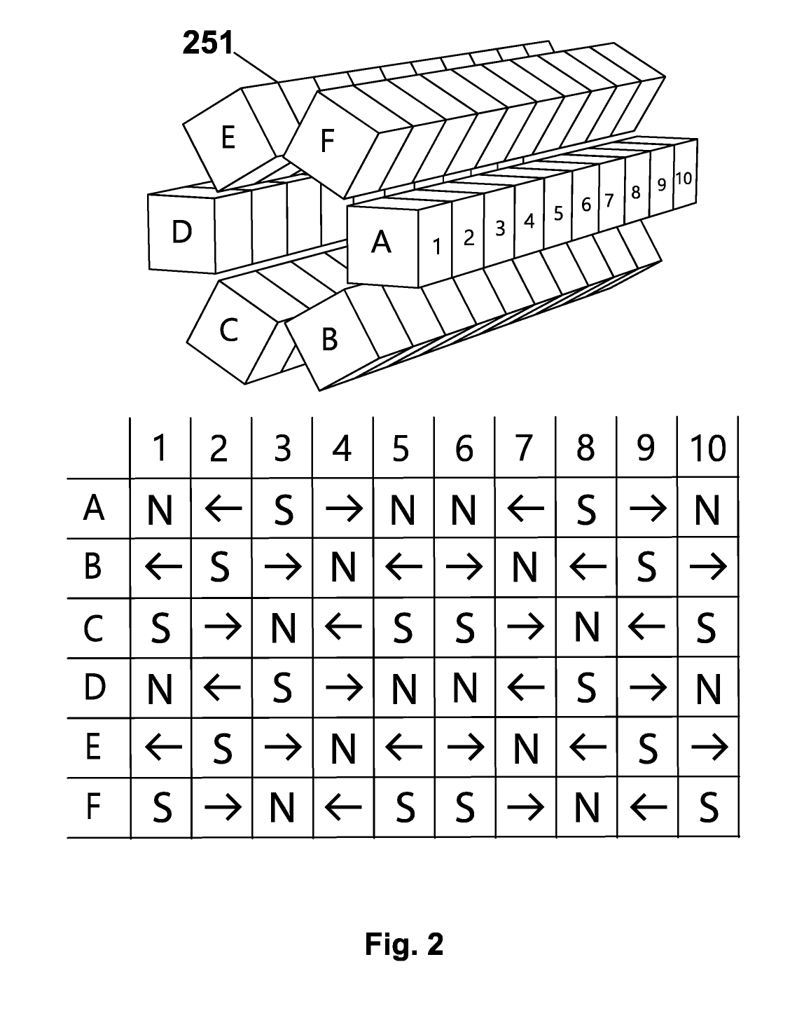

In FIG. 2, six linear Halbach arrays are arranged along a circumference to form a cylinder 251. Each major axis of the six Halbach arrays is parallel to the axis of the cylinder 251, and each Halbach array comprises ten cube magnets and is arranged to generate outward magnetic field. The magnets of the Halbach arrays are modeled as embedded in an aluminum frame. This kind of cylinder is referred to as “caterpillar”.

The magnets are one inch cube Neodymium alloy magnets of strength N50, each magnet of different sizes, shapes and materials can be utilized and this example is provided for the purpose of illustration only.

For a given number of magnets of a particular cubic size, the distance between adjacent magnets along the circumference of the caterpillar can be adjusted such that the magnet's edges are touching or are a small distance apart. With this example using six magnets along the circumference, a hexagonal structure would be formed. When the magnets are brought together, the magnitude of the lift and drag which is generated per magnet can be increased relative to when the magnets are spaced farther apart. In one embodiment, trapezoidal shaped magnets can be utilized to allow the magnets to touch one another when arranged around a rotational axis. A different trapezoidal angle can be used to accommodate different total number of magnets, such as six magnets (60 degrees), eight magnets (45 degrees), etc. A combination of rectangular and triangular shaped magnets can also be used for this purpose. For example, triangular magnets can be placed between the cubic magnets shown in FIG. 2.

The caterpillar 251 is rotated by a motor coupled herewith, and the axis of the rotation of the caterpillar is substantially parallel to a conductive substrate (not shown). In this case, the movement of each linear Halbach arrays relative to the conductive substrate can be decomposed into two component movements in two directions, one component movement is perpendicular to the conductive substrate, the other component movement is parallel to the conductive substrate. when the caterpillar is rotated above the substrate, each linear Halbach array of the caterpillar 251 can be regarded as moving reciprocally up and down between the top and bottom of the caterpillar 251, and moving forward reciprocally left and right between left end and right end of the caterpillar 251. The direction of left and right movement is parallel to the minor axis of the array.

When the caterpillar is rotated above the conductive substrate, eddy currents are induced in the substrate. An electromagnetic interaction occurs where the circulating eddy currents generate a magnetic field which repels the arrangement of magnets such that lifting forces are generated.

When the caterpillar 251 rotates clockwise, the Halbach arrays on the right side of the axis move downward and the Halbach arrays on the left side of the axis move upward over the conductive substrate. According to Lenz's law, eddy currents of the conductive plate will produce upward force on the Halbach arrays on the right side of the axis, and produce downward force on the Halbach arrays on the left side of the axis, these forces act on the Halbach arrays produce a counter clockwise torque to slow the rotation of the caterpillar. The torque is overcome by an input torque supplied by a motor coupled to the caterpillar.

When the caterpillar 251 rotates clockwise, the Halbach arrays above the axis move to right and the Halbach arrays beneath the axis move to left over the conductive substrate, and the relative motion is in the direction of the Halbach array's minor axis. As described above, magnetic fields of the Halbach arrays are almost equal along the minor axis, it will generate smallest eddy currents in the conductive plate and the lateral thrust between the array and the substrate appears negligible and there is only lifting force between the caterpillar 251 and conductive plate. When the caterpillar 251 is rotated above the conductive plate, and the axis of the rotation is parallel to the conductive substrate, if it can generate a moving magnetic field over the conductive substrate along the axis of rotation, a thrust between the conductive substrate and the caterpillar along the axis of rotation would be produced, this will be explained below in more detail below.

In one embodiment, the conductive substrate is formed from copper. In particular, three one eighth inch sheets of copper layered on top of one another are used. Other conductive materials can be used. Thus, a substrate formed from copper sheets is described for the purposes of illustration only. Curved surfaces may be formed more easily using a number of layered thin sheets. The thickness of the conductive material which is used can depend on the material properties of the conductive material, such as its current carrying capacity and the amount of magnetic lift which is desired. A particular caterpillar, depending on such factors, as the strength of the output magnetic field, the rate of movement of the magnetic field and the distance of the caterpillar from the surface of a conductive plate can induce stronger or weaker eddy currents in a particular conductive substrate material. Different caterpillars can be configured to generate different amounts of lifts and thus, induce stronger or weaker eddy currents.

The current density associated with induced eddy currents in the material can be a maximum at the surface and then can decrease with the distance from the surface. In one embodiment, the current density which is induced at the surface can be on the order of one to ten thousand amps per centimeter squared. As the conductive material becomes thinner, it can reach a thickness where the amount of current potentially induced by the caterpillar is more than the conductive material can hold. At this point, the amount of magnetic lift output from the caterpillar can drop relative to the amount of lift which would be potentially generated if the conductive material was thicker.

As the thickness of the material increases, the induced currents become smaller and smaller with increasing distance from the surface. After a certain thickness is reached, additional material results in very little additional lift. In various embodiments, the amount of copper which can be used varied depending on the application. For example, for a small scale model of a caterpillar configured to carry a doll, a ⅛ inch sheet of copper may be more than sufficient. As another example, a plate with a thinner amount of conductive material can lead to less efficient lift generation as compared to plate with a thicker amount of a more conductive material. However, the cost of the conductive material can be traded against the efficiency of lift generation.

A substrate can include a portion which is configured to support induced eddy currents. In addition, it can include portions used to add mechanical support or stiffness, to provide cooling and/or to allow a track portions to be assembled. For example, pipes or fins can be provided which are configured to remove and/or move heat to a particular location. In another example, the substrate can be formed as a plurality of tiles which are configured to interface with one another. In yet another example, the portion of the substrate which is used to support the induced eddy currents may be relatively thin and additional materials may be added to provide structural support and stiffness.

In various embodiments, the portion of the substrate used to support induced eddy currents may be relatively homogenous in that its properties are substantially homogeneous in depth and from location to location. For example, a solid sheet of metal, such as silver, copper or aluminum can be considered substantially homogenous in it's in depth properties and from location to location. As another example, a conductive composite material, such as a polymer or composite, can be used where the material properties on average are relatively homogeneous from location to location and in depth.

In other embodiments, the portion of the substrate used to support the induced eddy currents can vary in depth but may be relatively homogeneous from location to location. For example, the portion of the substrate which supports the eddy currents can be formed from a base material which is doped with another material. The amount of doping can vary in depth such that the material properties vary in depth.

In other embodiments, the portion of the substrate which supports the eddy currents can be formed from layers of different materials. For example, an electric insulator may be used between layers of a conductive material, such as layers of copper insulated from one another. In another example, one or more layers of a ferromagnetic material can be used with one or more paramagnetic materials or diamagnetic materials.

In yet another example, the surface of the substrate which supports the eddy currents can include a surface structure, such as raised or sunken dimples which effect induced eddy currents or some other material property. Thus, from location to location there may be slight variations in material properties but averaged over a particular area the material properties may be relatively homogeneous from location to location.

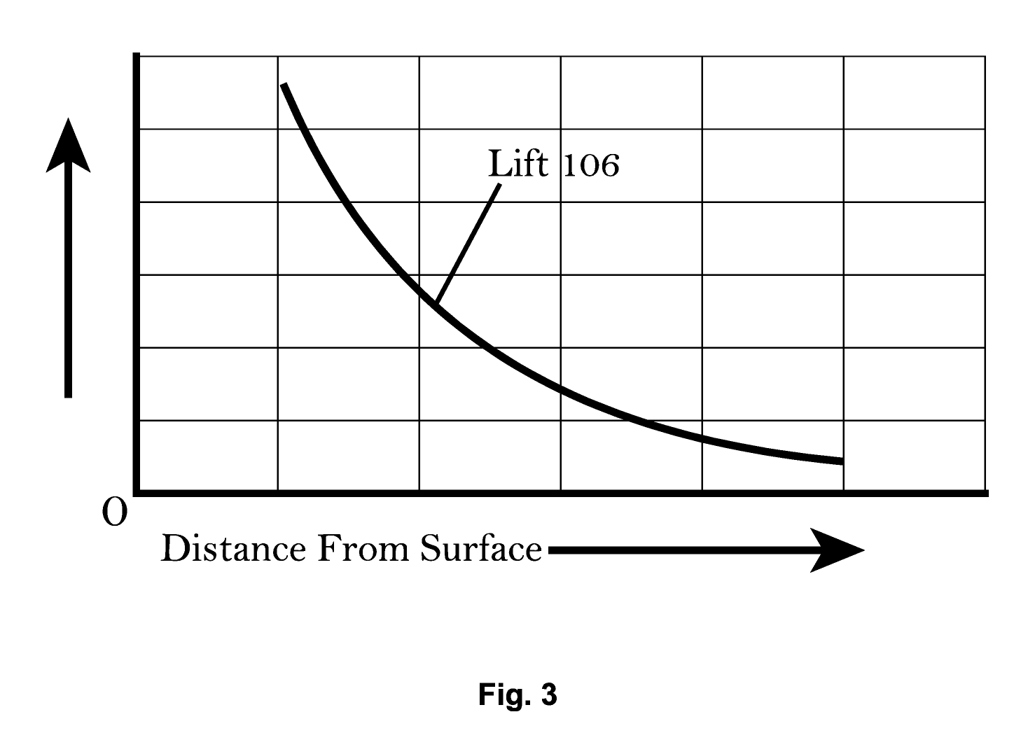

FIG. 3 is a is a plot of lift force associated with a caterpillar of rotating as a function of distance from a conductive substrate. In this example, a configuration of a caterpillar similar to shown in FIG. 2 was simulated. The plot is based upon a number of simulations at a constant RPM. The lift appears to follow an exponential decay curve as the distance from the surface of the conductive plate increases.

When a caterpillar is suspended by the lift force, if applying additional downward force on the caterpillar, the caterpillar will decline and its distance from the surface of the plate will decrease, thus the lift force between the conductive plate and the caterpillar would increase to balance the additional downward force on the caterpillar. when the additional downward force on the caterpillar is cancelled, the lift force will drive the caterpillar up, thus the lift force between the conductive plate and the caterpillar would decrease until the caterpillar restored to its initial position. This means the lifting system is dynamically stable.

### Magnetic Lift Systems Including Thrust

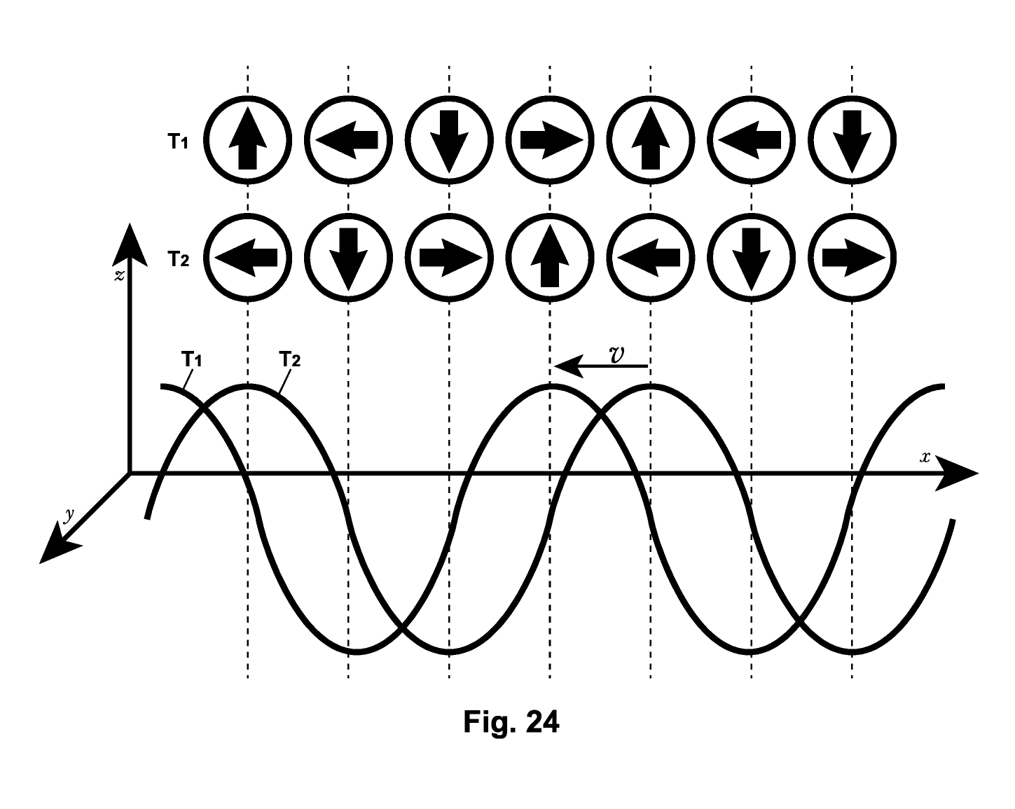

Next, some details about the thrust along the axis of rotation the caterpillar are described with respect to FIGS. 24A-34B. In particular embodiments, an orientation of one or more caterpillars relative to a substrate can be used to generate thrust and/or control forces. Other mechanisms of propulsion are possible, along or in combination with controlling the caterpillar orientation to generate propulsive and directional control forces. Thus, these examples are provided for the purpose of illustration only and are not meant to be limiting.

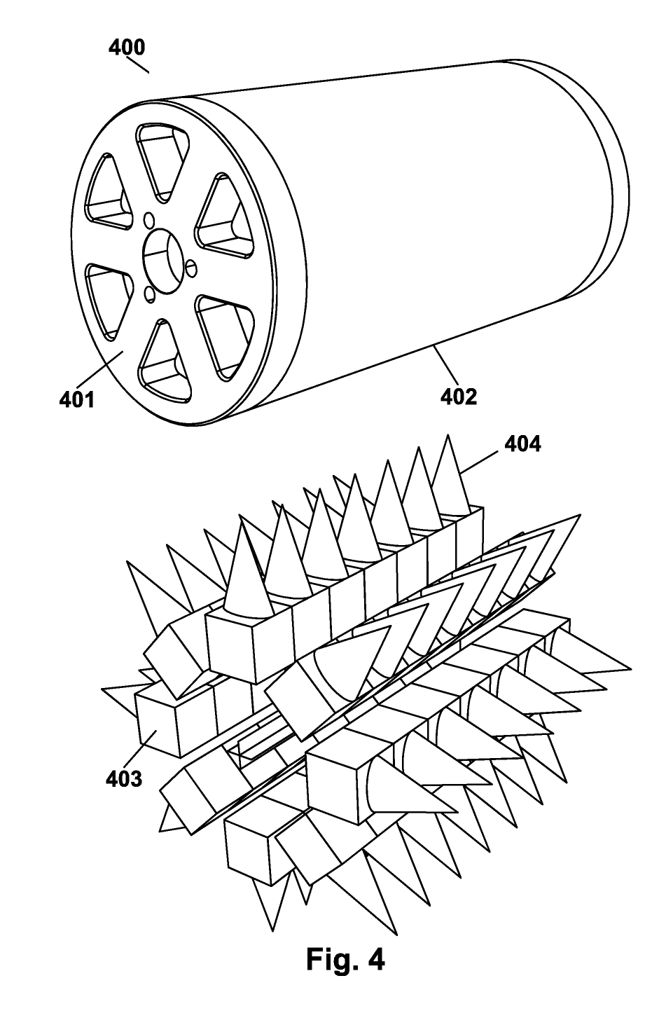

FIG. 4 shows a magnet structure 400 comprises caterpillar 403 having eight linear Halbach magnet arrays, the caterpillar 403 generates outward magnetic field 404. The caterpillar 403 is encircled by frame 401 and 402.

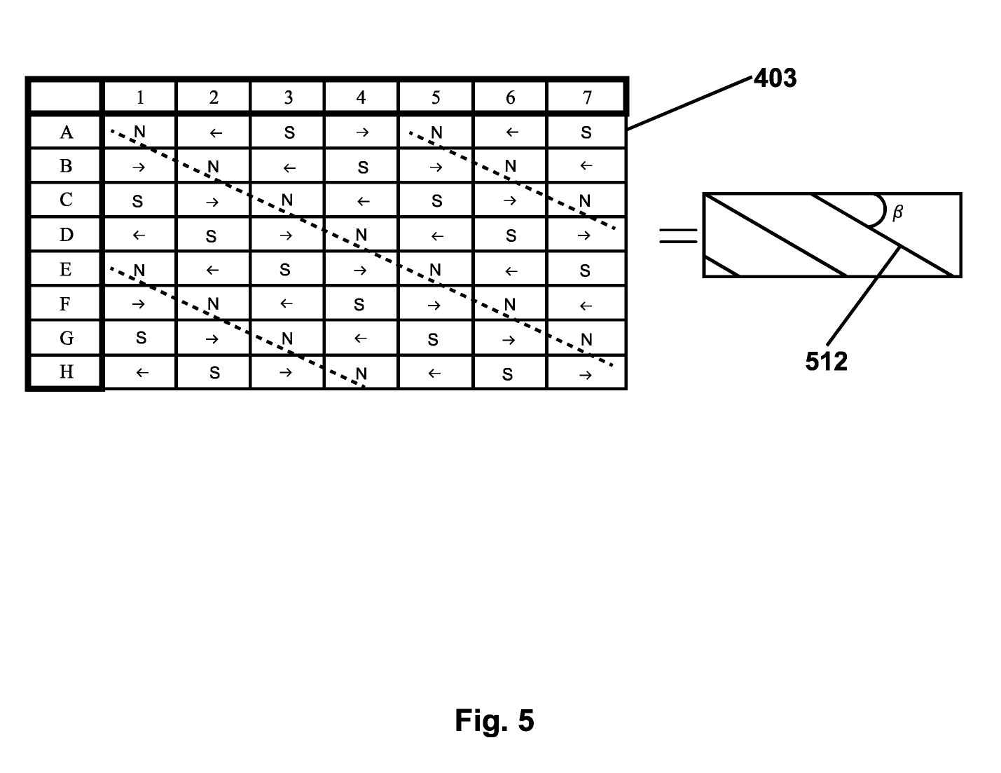

The caterpillar 403 is cut along its axis of rotation and unrolled to a polarity pattern of magnets shown In FIG. 5, the caterpillar 403 comprises eight linear Halbach arrays, each is shown on a row. Each linear Halbach array comprises seven piece's magnets. The number of magnets in a row represents the number in each array. The number of magnets in a column represents the number of arrays which exchange in one rotation of the caterpillar. “N” indicate a north pole of a magnet and “S” indicate a south pole of a magnet, “<” indicate the orientation of a magnet is leftward and “>” indicate the orientation of a magnet is rightward.

Referring to FIG. 5, the rotating angle of the orientation of each piece's magnetic field between adjacent magnets in a linear Halbach array is 90 degrees. The series orientation of each of magnets on a column exchanged in a rotation, as a position along the axis of the caterpillar. More specifically, the orientation of each piece's magnetic field in linear Halbach array A is upward, leftward, downward, rightward, upward, leftward and downward respectively from left end to right end of the array. The orientation of each piece's magnetic field in linear Halbach array B falls behind the orientation of each piece's magnetic field in linear Halbach array A by an interval of a magnet. The orientation of each piece's magnetic field in other Halbach arrays such as Halbach arrays C, D, E, F, G, H falls behind the orientation of each piece's magnetic field in adjacent above Halbach arrays each by an interval of a magnet.

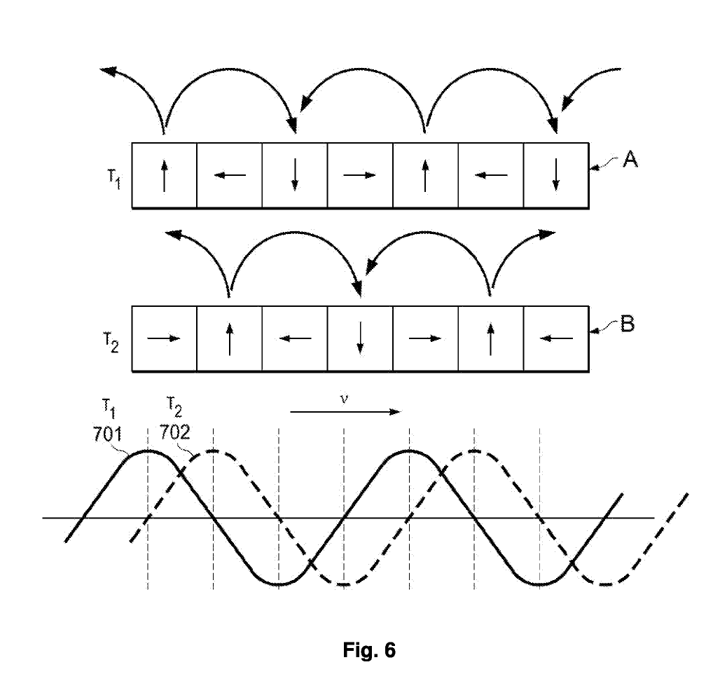

When the caterpillar 403 is rotated over a conductive plate with its axis of rotation parallel to the conductive substrate, it will generate thrust along the axis between the caterpillar 403 and the conductive substrate. Referring to FIG. 6, at time T1, the linear Halbach array A is on the bottom of the caterpillar 403, the linear Halbach array A is the nearest Halbach array from the conductive substrate. Compared with other Halbach array of the caterpillar, Halbach array A can generate strongest magnetic field on the conductive substrate and thus produces strongest interaction between the Halbach array and the conductive substrate. Therefore, distribution of magnetic field of the bottom linear Halbach array will be described in detail. As described above, the distribution of magnetic field of Halbach array A along the major axis is an approximately sinusoidal waveform 701, the wavelength λ is an interval of four magnets, and the peak of the sinusoidal waveform is aligned with the center of the magnet on the left end of the Halbach array A. The direction of the magnetic field is approximately perpendicular to the conductive substrate.

At time T2, the caterpillar is rotated counter clockwise by 45 degrees, such that the linear Halbach array B is on the bottom of the caterpillar 403. The distribution of magnetic field of Halbach array B along the major axis is an approximately sinusoidal waveform 702, the wavelength λ is an interval of four magnets, and the peak of the sinusoidal waveform is aligned with the center of the magnet of the second left of Halbach array B. The direction of the magnetic field is approximately perpendicular to the conductive plate.

The caterpillar 403 is rotated counter clockwise by 45 degrees, the effect to the distribution of magnetic field above the conductive plate is that the sinusoidal waveform 701 is substituted by sinusoidal waveform 702, because sinusoidal waveform 701 and sinusoidal waveform 702 have the same wave shape, only have a distance of ¼λ of the sinusoidal waveform along the axis of rotation, which is equivalent to that the sinusoidal waveform 701 travels a distance of ¼λ from left to right along the axis of rotation. Similarly, continuing rotated the caterpillar counter clockwise, the caterpillar will generate a continuously moving sinusoidal waveform from left to right along the axis of rotation over the conductive plate, the continuously moving sinusoidal waveform is a travelling electromagnetic wave.

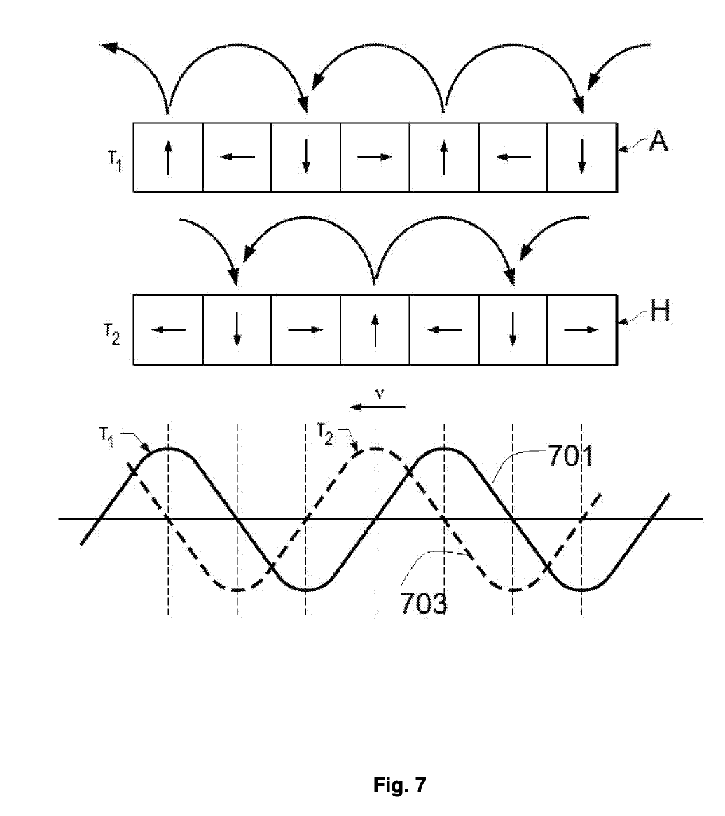

In operation, when the caterpillar 403 is rotated clockwise by 45 degrees, a travelling electromagnetic wave from right to left along the axis of rotation over the conductive plate can be generated. The analysis is as follows with respect to FIG. 7.

In FIG. 7, at time T1, the linear Halbach array A is on the bottom of the caterpillar. As described above, the distribution of magnetic field of Halbach array A along the major axis is an approximately sinusoidal waveform 701. At time T2, the caterpillar 403 is rotated clockwise by 45 degrees, such that the linear Halbach array H is on the bottom of the caterpillar. The distribution of magnetic field of Halbach array H along the major axis is an approximately sinusoidal waveform 703, sinusoidal waveform 701 and sinusoidal waveform 703 have the same wave shape, only have a distance of ¼ λ along the axis of rotation, which is equivalent to that the sinusoidal waveform 701 travels a distance of ¼ λ of the sinusoidal waveform from right to left along the axis of rotation. It is thus clear that changing the direction of the rotation of the caterpillar can change the moving direction of travelling electromagnetic wave.

Referring back to FIG. 5, the peak of the electromagnetic wave in the FIG. 5 are connected by three parallel oblique lines 512, the intersection angle β between the major axis of the Halbach array and the oblique lines 512 is referred to as “direction angle” herein. When the direction angle is less than 90 degrees, the orientation of each piece's magnetic field in linear Halbach array B falls behind the orientation of each piece's magnetic field in linear Halbach array A. The orientation of each piece's magnetic field in other Halbach arrays such as Halbach arrays C, D, E, F, G, H falls behind the orientation of each piece's magnetic field in adjacent Halbach arrays. As described above, when the caterpillar is rotated counter clockwise, travelling electromagnetic wave generated by the caterpillar moves from left to right. But when the direction angle is larger than 90 degrees, the orientation of each piece's magnetic field in linear Halbach array B is in advance of the orientation of each piece's magnetic field in linear Halbach array A. The orientation of each piece's magnetic field in other Halbach arrays such as Halbach arrays C, D, E, F, G, H is in advance of the orientation of each piece's magnetic field in adjacent Halbach arrays. when the caterpillar is rotated counter clockwise, travelling electromagnetic wave generated by the caterpillar moves from right to left.

Therefore, changing rotation direction of the caterpillar or changing direction of rotation of the caterpillar can alter the moving direction of the travelling electromagnetic wave generated by the rotation of the caterpillar above a conductive substrate.

The travelling electromagnetic wave over the conductive substrate generated by rotating the caterpillar is similar to a travelling electromagnetic wave over a stator generated by alternate currents in a rotor of a linear induction motor. The difference is that the mechanical motion of the caterpillar generates a travelling electromagnetic wave in the conductive plate, while spatially distributed alternate currents generate a travelling electromagnetic wave in the linear induction motor. The travelling electromagnetic wave between a rotor and a stator of a linear induction motor can induce eddy currents in the stator and generates force to make the rotor move along the travelling electromagnetic wave over the stator. And when the rotor moves over the stator, induced eddy currents can further generate magnetic field to lift the rotor to make the rotor suspend over the stator. According to the theory of the linear induction motor, the speed of the movement of a rotor is nearly but slightly less than the speed of the movement of travelling electromagnetic wave.

A caterpillar is similar to a rotor of a linear induction motor and a conductive plate is similar to a rotor of the linear induction motor, similarly, the travelling electromagnetic wave between a caterpillar and a conductive plate can induce eddy currents in the conductive plate and generates force to lift the caterpillar and thrust the caterpillar to move along the travelling electromagnetic wave over the conductive plate. the speed of the movement of a caterpillar is nearly but slightly less than the speed of the movement of travelling electromagnetic wave.

Referring back to FIG. 6, if the length of each of the magnet along the major axis of the Halbach array is 12 mm, the wavelength λ generate by the Halbach array is 48 mm. with each exchange at 45 degrees of rotation of the caterpillar, the travelling electromagnetic wave will translate ¼ λ (i.e., 12 mm). One rotation of the caterpillar is equivalent to 2λ electromagnetic wave translation (i.e., 96 mm). 10,000 RPM is equivalent to 960,000 mm per minute or 16m per second, 100m per second is equivalent to 62,500 RPM. Of course, the speed of the caterpillar is nearly but slightly less than the speed of the movement of travelling electromagnetic wave.

In FIG. 6, phase increment of a caterpillar is defined as a change of the phase of the travelling electromagnetic wave when the caterpillar rotates a unit angle. The translation speed of a caterpillar along its axis of rotation is related to RPM of the caterpillar, wavelength of electromagnetic wave and phase increment of the caterpillar.

When the structure of a caterpillar is fixed, the translation speed of the caterpillar is determined by the RPM of the caterpillar, the higher speed of RPM, the higher translation speed of the caterpillar can get.

When the RPM of a caterpillar is fixed, the translation speed of the caterpillar is determined by the wavelength of electromagnetic wave and phase increment of the caterpillar, the longer of the wavelength of electromagnetic wave and the larger of the phase increment, the higher translation speed of the caterpillar can get.

In order to lengthen the wavelength of electromagnetic wave, rotating angle of the orientation of each piece of magnet's magnetic field between adjacent magnets in a linear Halbach array may be decreased. for example, if a rotating angle is 90 degrees, the wavelength of the Halbach array is the sum of length of four magnets; if a rotating angle is 60 degrees, the wavelength of the Halbach array is the sum of length of six magnets; and if the rotating angle is 45 degrees, the wavelength of the Halbach array is the sum of length of eight magnets. Further, lengthening each piece of magnet's length along the major axis can also lengthen the wavelength of electromagnetic wave.

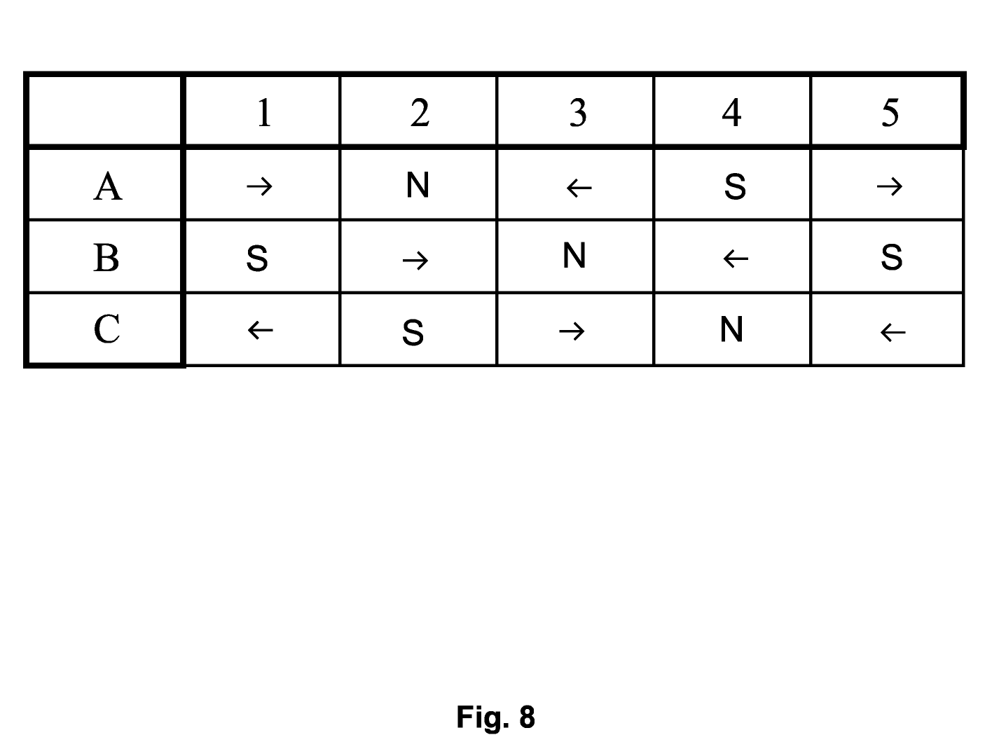

Based on the operational theory of the caterpillar as described above, various caterpillars can be constructed in different applications. Next, a few examples of caterpillars are described with respect to FIGS. 8-17. FIGS. 8-17 are illustrations of caterpillars which can generate travelling electromagnetic wave on a conductive substrate. each arrangement of different numbers, orientations and shapes can be utilized and these examples are provided for the purpose of illustration only. The caterpillars in FIGS. 8-17 are cut along their axes of rotation and unrolled to show their polarity patterns of magnets.

Caterpillars which can generate unidirectional travelling electromagnetic wave are shown in FIGS. 8-10. In FIG. 8, a caterpillar is composed of three linear Halbach arrays which are parallel to the axis of the caterpillar along the circumference of the caterpillar. each of the Halbach array comprises five magnets, the direction angle of the caterpillar is less than 90 degrees, when the caterpillar rotate counter clockwise with its rotational axis parallel to a conductive substrate, as above described, the moving direction of a travelling electromagnetic wave on the conductive plate generated by the caterpillar is from left to right, thus the thrust generated by eddy currents in the conductive plate will lift the caterpillar and promote the caterpillar to move from right to left. When the caterpillar rotates by one turn (i.e., 360 degrees), the travelling electromagnetic wave moves ¾λ of the electromagnetic wave, thus the caterpillar will move a distance nearly ¾λ of the electromagnetic wave from right to left. Similarly, when the caterpillar rotates clockwise, it will be lifted and promoted to move from left to right.

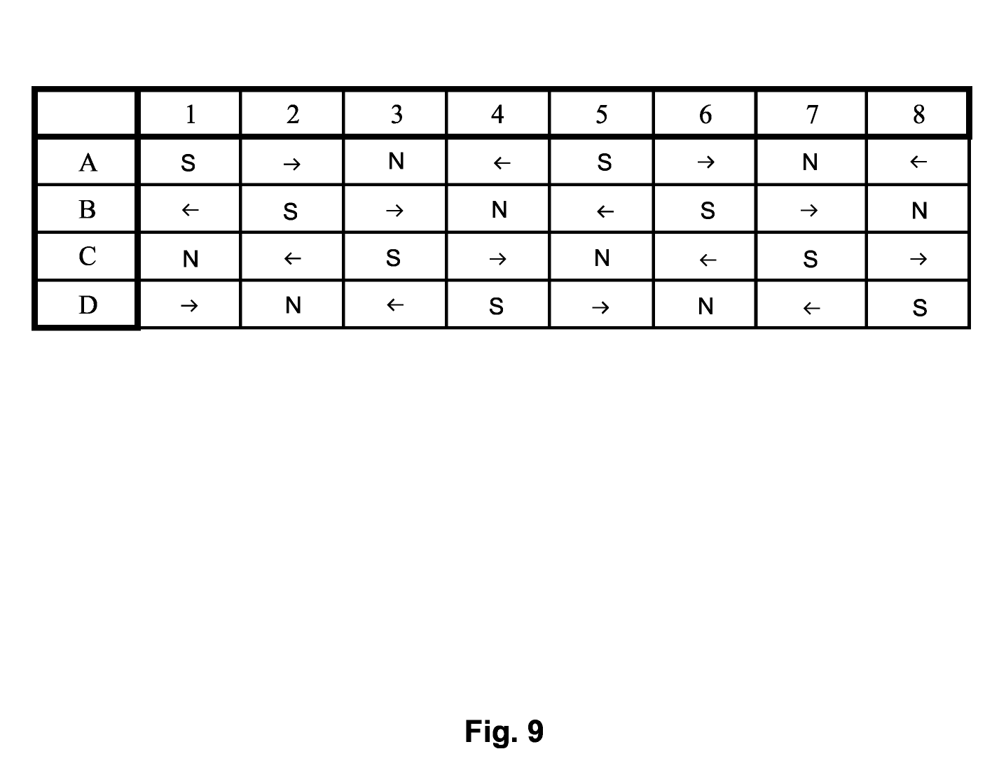

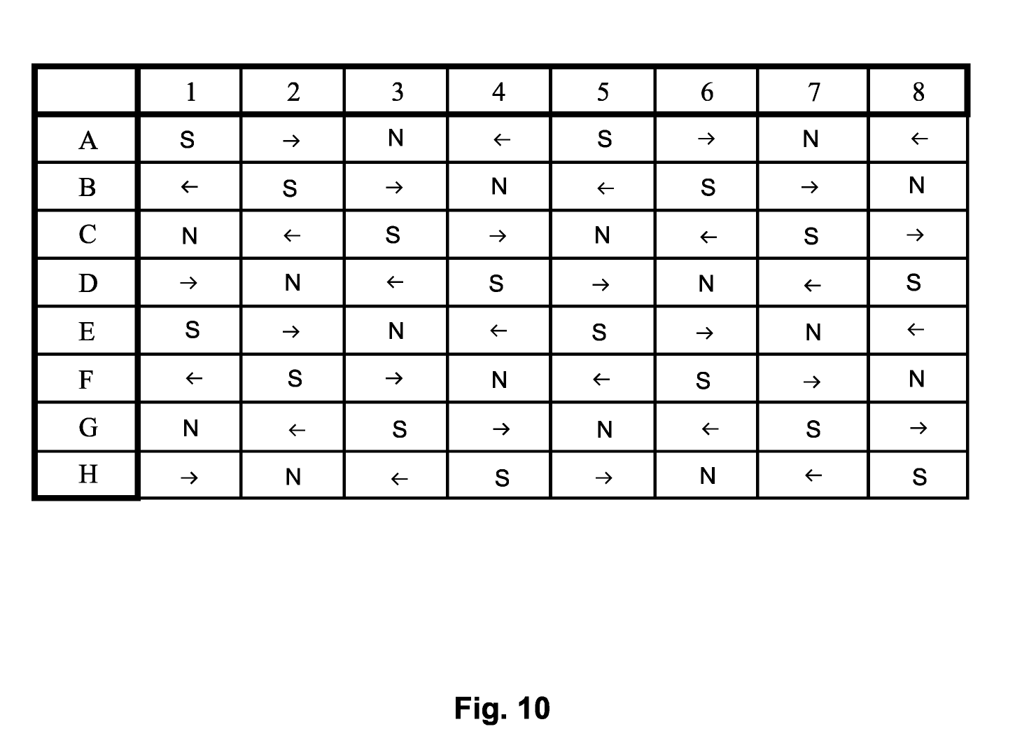

In FIG. 9, a caterpillar is composed of four linear Halbach arrays and each of the Halbach array comprises eight magnets, the direction angle of the caterpillar is also less than 90 degrees. When the caterpillar rotates counter clockwise by one turn, it will move a distance almost one 2 of the electromagnetic wave from right to left. In FIG. 10, a caterpillar is composed of eight linear Halbach arrays and each of the Halbach array comprises eight magnets, the direction angle of the caterpillar is less than 90 degrees. When the caterpillar rotates counter clockwise by one turn, it will move a distance close to 22 of the electromagnetic wave from right to left.

The direction angles in FIGS. 8-10 are identical. the phase increment of the caterpillar in FIG. 10 is the highest, and the phase increment of the caterpillar in FIG. 10 is the smallest. as a result, if the magnets of the caterpillars have the same sizes, in the case of the same rotation speed of the caterpillars, the translation speed of the caterpillar in FIG. 10 is the highest, and the translation speed of the caterpillar in FIG. 8 is the smallest. If higher speed is desired, we can increase the phase increment of a caterpillar, while the number of linear Halbach arrays and radius of the caterpillar will increase accordingly, which will increase moment of inertia of the caterpillar. in some control application, high speed and low moment of inertia of the caterpillar are desired at the same time, to meet this requirement, a small radius caterpillar is rotated by a high speed motor.

Each Halbach array in FIG. 8 comprises five magnets and each Halbach array in FIG. 10 comprises eight magnets, in the case of the same rotation speed of the caterpillars, forces generated by eddy currents in the conductive plate which act on the caterpillar in FIG. 10 will larger than that act on the caterpillar in FIG. 8. Therefore, if more thrust is desired, we can increase the length of a caterpillar, while the mass of the caterpillar will increase accordingly.

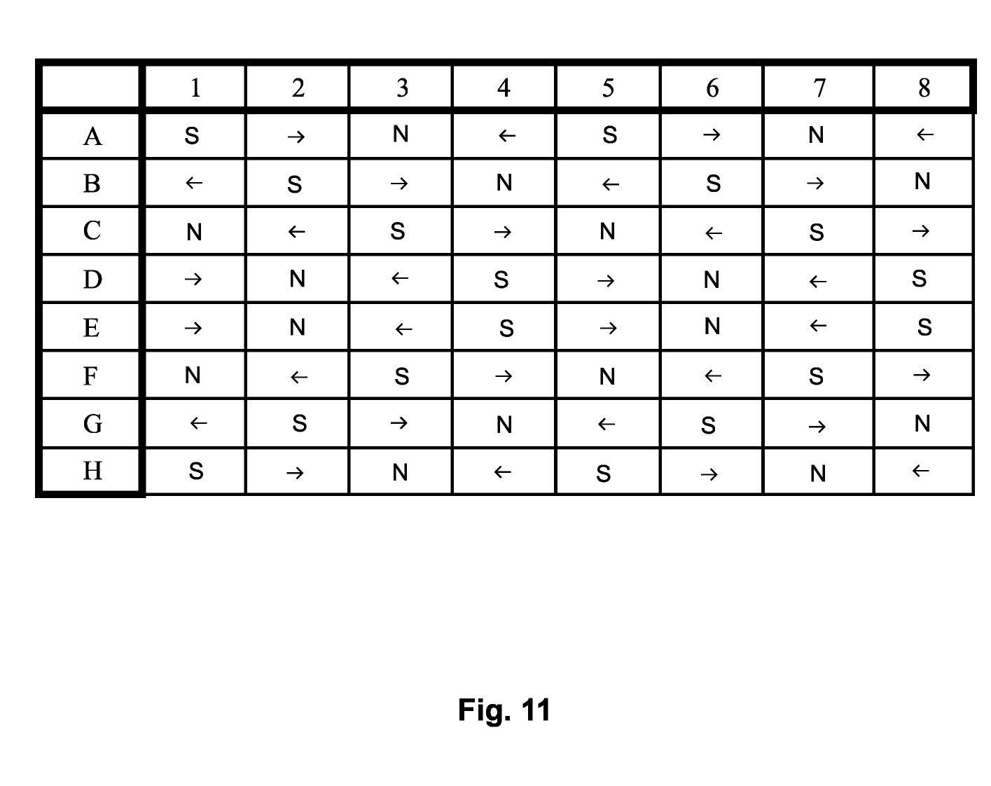

Caterpillars which can generate oscillation are shown in FIGS. 11-13. In FIG. 11, a caterpillar is composed of eight linear Halbach arrays which are parallel to the axis of the caterpillar along the circumference of the caterpillar, and each of the Halbach array comprises eight magnets, from Halbach array A to Halbach array D, the direction angle of the caterpillar is less than 90 degrees. at the start, the Halbach array A is at the bottom of the caterpillar, when the caterpillar rotates counter clockwise with its rotational axis parallel to a conductive plate, until the Halbach array D at the bottom of the caterpillar, as above described, the moving direction of a travelling electromagnetic wave on the conductive plate generated by the caterpillar is from left to right, thus the thrust generated by eddy currents in the conductive plate will lift the caterpillar and promote the caterpillar to move from right to left. The direction angle of the caterpillar is larger than 90 degrees from Halbach array E to Halbach array H, when the caterpillar continues to rotate counter clockwise from Halbach array E to Halbach array H, as above described, the thrust generated by eddy currents in the conductive plate will lift the caterpillar and promote the caterpillar to move from left to right.

Similarly, at the start, the Halbach array A is at the bottom of the caterpillar, when the caterpillar rotates clockwise by one revolution with its rotational axis parallel to a conductive plate, it will bear force from left to right during the first half cycle and bear force from right to left during the second half cycle.

No matter what rotational direction of the caterpillar in FIG. 11, as long as the caterpillar continuously rotates with its rotational axis parallel to a conductive plate, it will bear opposite direction forces along the rotational axis periodically, which makes the caterpillar move reciprocally along the rotational axis.

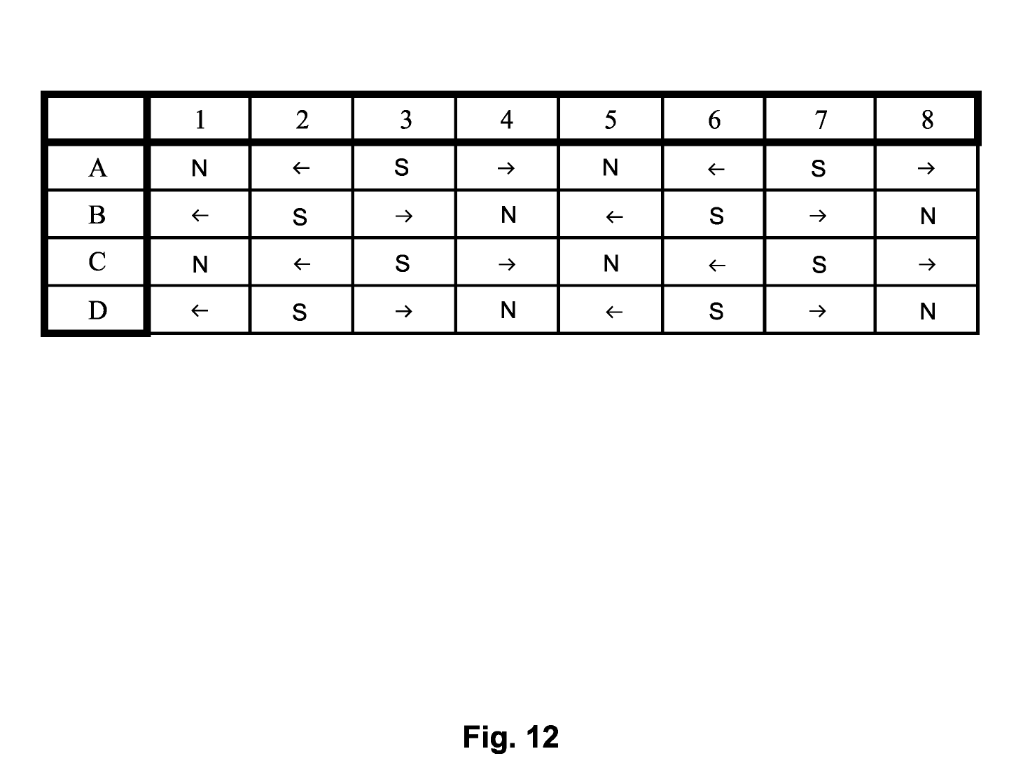

In FIG. 12, a caterpillar is composed of four linear Halbach arrays and each of the Halbach array comprises eight magnets, the direction angle of the caterpillar is less than 90 degrees from Halbach array A to Halbach array B, larger than 90 degrees from Halbach array B to Halbach array C, less than 90 degrees from Halbach array C to Halbach array D and then larger than 90 degrees from Halbach array D to Halbach array A. Similar to above description, no matter what rotational direction of the caterpillar, as long as the caterpillar continuously rotates with its rotational axis parallel to a conductive plate, it will bear opposite direction forces along the rotational axis periodically, which makes the caterpillar move reciprocally along the rotational axis. One difference between FIG. 11 and FIG. 12 is as follow, when the caterpillar rotates one revolution, the caterpillar in FIG. 11 moves reciprocally along the rotational axis once, while the caterpillar in FIG. 12 moves reciprocally along the rotational axis twice.

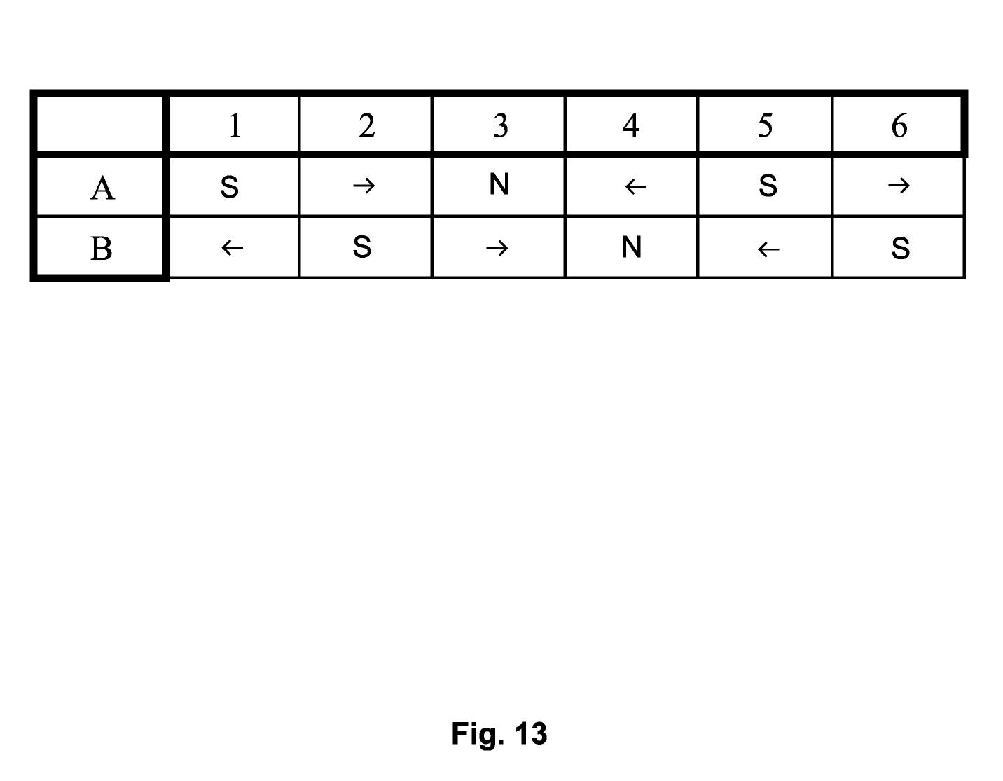

In FIG. 13, a caterpillar is composed of two linear Halbach arrays and each of the Halbach array comprises six magnets, the direction angle of the caterpillar is less than 90 degrees from Halbach array A to Halbach array B, larger than 90 degrees from Halbach array B to Halbach array A. In this case, when the caterpillar rotates by two revolutions, the caterpillar in FIG. 13 moves reciprocally along the rotational axis once.

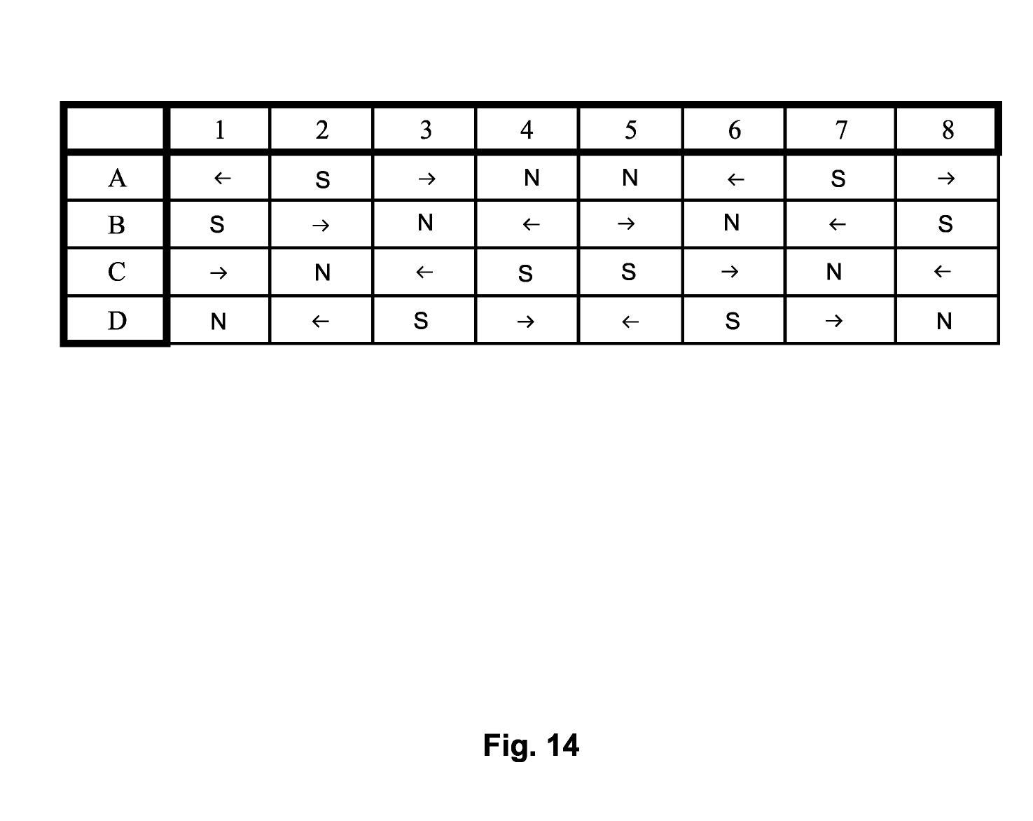

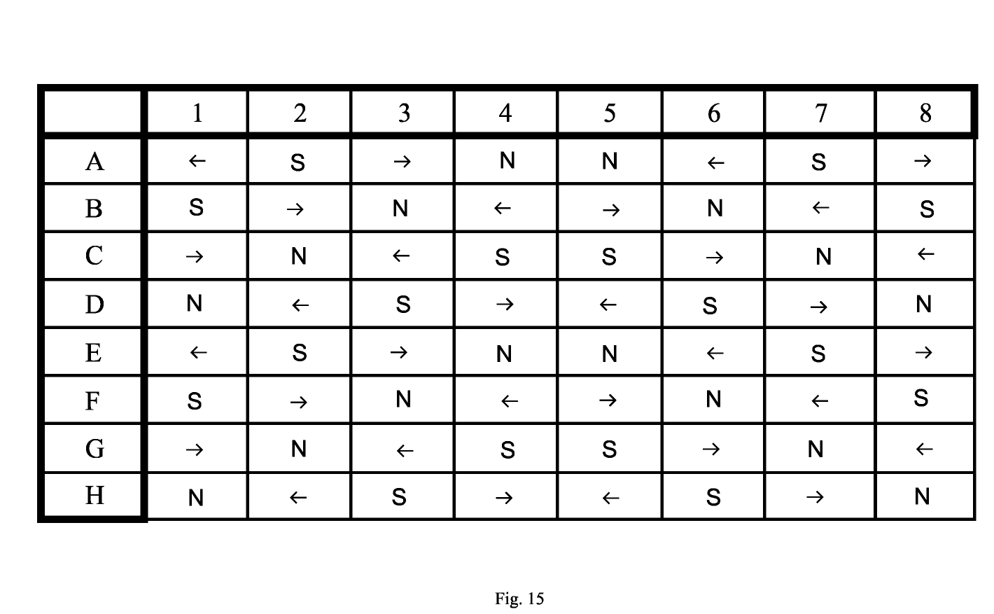

Caterpillars which can generate bidirectional thrust at the same time are shown in FIGS. 14 and 15. In FIG. 14, a caterpillar is composed of four linear Halbach arrays which are parallel to the axis of the caterpillar along the circumference of the caterpillar, and each of the Halbach array comprises eight magnets. The caterpillar can be considered as a combination of two subset caterpillars along the axis of the caterpillar. The left subset caterpillar comprises magnets from column 1 to column 4, The right subset caterpillar comprises magnets from column 5 to column 8. The direction angle of the left subset caterpillar is less than 90 degrees while the direction angle of the right subset caterpillar is larger than 90 degrees.

Similar to above description, no matter what rotational direction of the caterpillar in In FIG. 14, as long as the caterpillar rotates with its rotational axis parallel to a conductive plate, the direction of the thrust acting on the left subset caterpillar along the rotational axis is opposite to the direction of the thrust acting on the right subset caterpillar along the rotational axis. The net thrust on the caterpillar is the difference of the two thrusts acting on the two subset caterpillars. If the left subset caterpillar and the right subset caterpillar are symmetrical with respect to the boundary of them, net thrust will be equal to zero, the caterpillar will bear only lift and suspend motionlessly. And if the arrangement is not symmetrical, net thrust will be produced to drive the caterpillar to move along the rotational axis.

Similar to the caterpillar in FIG. 14, rotating the caterpillar in FIG. 15 can also generate two thrusts with opposite direction acting on the caterpillar, and net thrust on the caterpillar is the difference of the two thrusts.

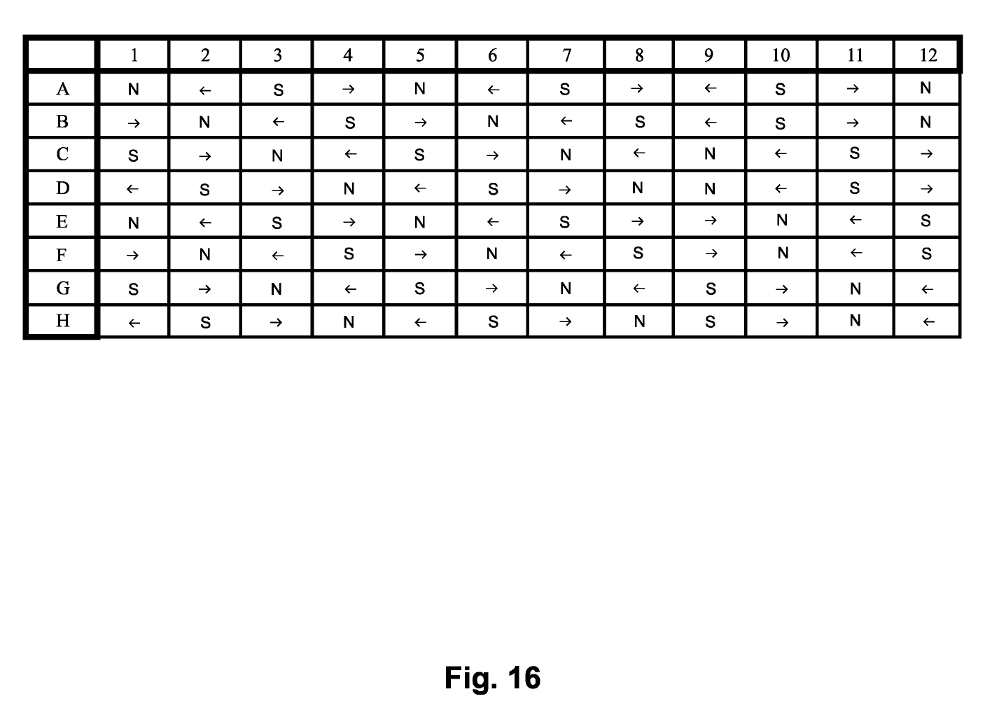

Caterpillar which has MultiRatio is shown in FIG. 16. In FIG. 16, a caterpillar is composed of eight linear Halbach arrays which are parallel to the axis of the caterpillar along the circumference of the caterpillar, and each of the Halbach array comprises twelve magnets. The caterpillar can be considered as a combination of two subset caterpillars along the axis of the caterpillar. The left subset caterpillar comprises magnets from column 1 to column 8, The right subset caterpillar comprises magnets from column 9 to column 12. The direction angles of the two subset caterpillars are all less than 90 degrees, and the direction angle of the left subset caterpillar is less than the direction angle of the right subset caterpillar.

No matter what rotational direction of the caterpillar in FIG. 16, as long as the caterpillar rotates with its rotational axis parallel to a conductive plate, the direction of the thrust acting on the left subset caterpillar along the rotational axis is the same as the direction of the thrust acting on the right subset caterpillar along the rotational axis due to that the direction angles of the two subset caterpillars are all less than 90 degrees.

When the caterpillar rotates one revolution, the traveling wave generated by the left subset caterpillar moves a distance of two wavelengths while the right subset caterpillar moves a distance of only one wavelength. The traveling wave speed of the right subset caterpillar is lower than that of the left subset caterpillar, but it can generate greater thrust than the left subset caterpillar. Therefore, the thrust generated by the caterpillar can adapted to various RPM and translation speeds or desired force/displacement ranges.

In FIG. 16, if changing the polarity of the magnets of the right subset caterpillar, such that the direction angle of it is larger than 90 degrees while the direction angles of the left is unchanged, the net thrust on the caterpillar will be the difference of the two thrusts acting on the two subset caterpillars.

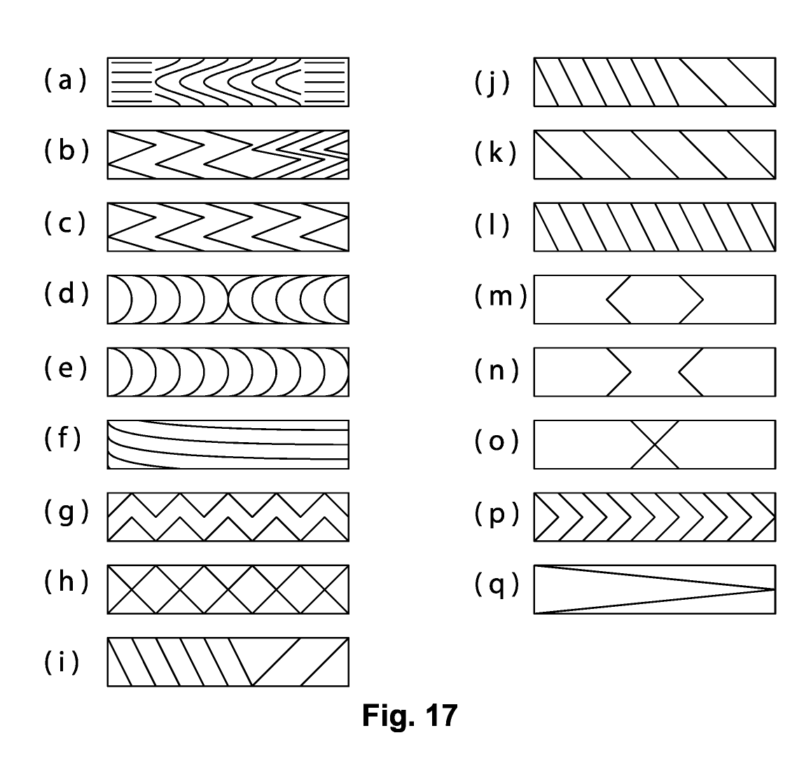

Other embodiments of caterpillars are shown in FIG. 17, the caterpillars are unrolled along their rotational axes, and only oblique lines connecting north magnets of the caterpillars are shown, which is correspond to the oblique lines connecting the peak of the electromagnetic wave generated by the caterpillars.

FIG. 17(a) shows an example of a caterpillar that includes cyclic acceleration with vibration or “hover” displacement. In FIG. 17(a), when the caterpillar rotates one revolution, the direction angle changes form less than 90 degree to larger than 90 degrees which can generate vibration of the caterpillar as described above. FIG. 17(b) shows an example that includes multi-rate opposite displacement or oscillation. In FIG. 17(b), different subsets have different direction angles to form a multi-ratio caterpillar. FIG. 17(c) shows an example that includes medium oscillation. FIG. 17(d) shows an example that includes cyclic acceleration and ratcheting with restoring, centering, or displacing function. In FIG. 17(d), the direction angle changes form less than 90 degree to larger than 90 degrees which can generate vibration, and direction angle changes at every point of the oblique lines, which will generate different thrusts along the axis and generate vibration. FIG. 17(e) shows an example that includes cyclic acceleration and linear actuation, with restoring, centering, or displacing function. FIG. 17(f) shows an example that includes variable or progressive rate linear actuation. FIG. 17(g) and FIG. 17(h) show examples similar to FIG. 14 that include static “hover” displacement without actuation.

FIG. 17(i) shows an example that includes a multi-ratio opposable actuation. FIG. 17(j) shows an example similar to FIG. 16 that includes a multi-ratio linear actuation. FIG. 17(g) and FIG. 17(h) show examples similar to FIG. 10 that include linear actuation. The wavelength of the caterpillar in FIG. 17(g) is larger than the wavelength of the caterpillar in FIG. 17(h), and the direction angle of the caterpillar in FIG. 17(g) is less than that of the caterpillar in FIG. 17(h), thus the translation speed of caterpillar in FIG. 17(g) is higher than that of the caterpillar in FIG. 17(h), but the thrust acting on the caterpillar in FIG. 17(g) is less than that acting on caterpillar in FIG. 17(h).

FIG. 17(i), FIG. 17(j) and FIG. 17(k) show examples that may include restoring or detenting or displacing actuation. FIG. 17(l) and FIG. 17(m) show examples that include oscillation. The wavelength of the caterpillar in FIG. 17(m) is larger than the wavelength of the caterpillar in FIG. 17(l), and the direction angle of the caterpillar in FIG. 17(m) is less than that of the caterpillar in FIG. 17(l), thus the oscillation speed of caterpillar in FIG. 17(m) is higher than that of the caterpillar in FIG. 17(l), but the thrust acting on the caterpillar in FIG. 17(m) is less than that acting on caterpillar in FIG. 17(l).

The shapes and arrangements of the caterpillars described above are provided for the purpose of illustration only. A caterpillar can have various shapes and arrangements not necessarily the Halbach array, only if rotating the caterpillar about its axis, the caterpillar can generate travelling magnetic field along its axis. In an embodiment, a caterpillar is composed of an axially organized assembly of linear, spiral, arc, or body of revolution subset format array(s) which can be incremental or progressed by rotation. In an embodiment, a caterpillar may be progressed by rotation or partial rotation relative to singular or multiple positions. In an embodiment, rotary phase increment between array elements at positions, along axis of rotation, may be independent of equal subdivision of a revolution by a value equal to the number of actual or nominal polar magnet positions or array positions. In an embodiment, assembly may be cylindrical, substantially cylindrical, conic, substantially conic, and/or uniformly or nonuniformly curved in surface or body of revolution. In an embodiment, a caterpillar can have rotating disk, cartridge, cylinder, conic, spiral, or surface of revolution format. In an embodiment, a caterpillar can be composed of subsets in disk, linear, or spiral form. In an embodiment, surface or body of revolution of a caterpillar can be discontinuous as in arc segments or profile segments in single or multiple instances in a given assembly. In an embodiment, permanent magnets are used. In an embodiment, electromagnets are used. In an embodiment, electromagnets are used instead of permanent magnets.

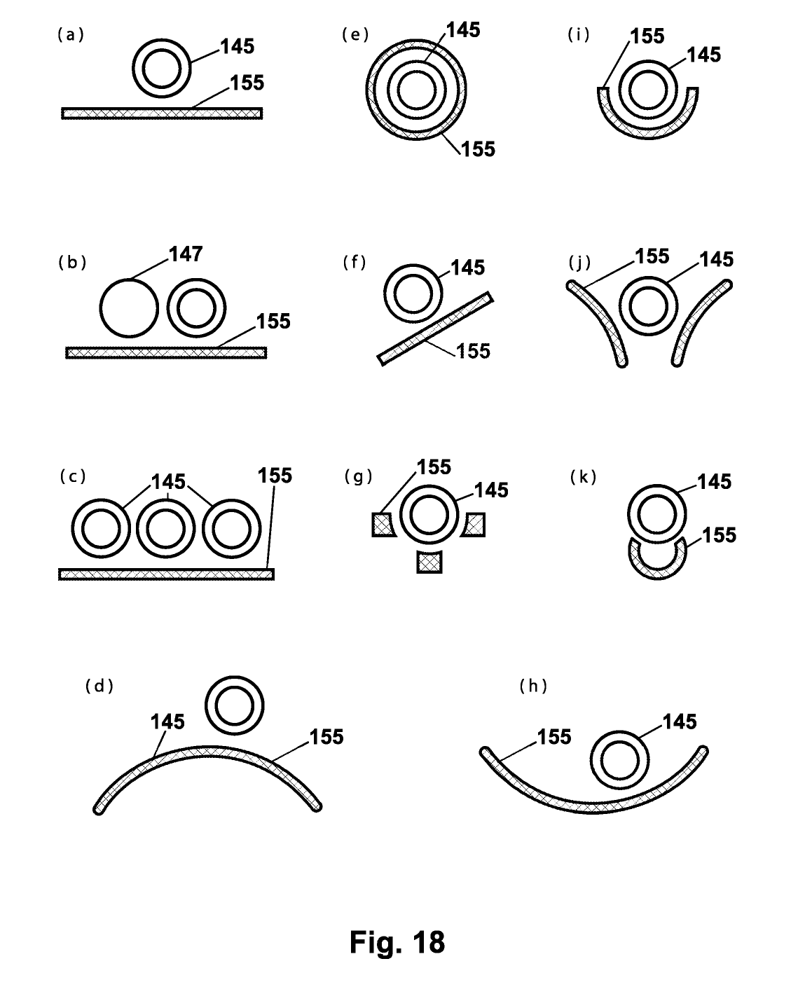

The conductive substrate can have a plane surface or a curved surface to interact with one or a plurality of caterpillars, FIG. 18 shows examples of various electromechanical systems. Each conductive substrate 155 in FIG. 18(a), FIG. 18(b), FIG. 18(c), FIG. 18(f) has plane surface. In FIG. 18(a), only one caterpillar 145 interacts with a substrate 155. In FIG. 18(b), a solid caterpillar 147 and a ring caterpillar 145 interacts with a substrate 155. In FIG. 18(c), three ring caterpillars 145 interacts with a substrate 155. The plane surfaces in FIG. 18(a), FIG. 18(b), FIG. 18(c) are level but the plane surface of the substrate 155 in FIG. 18(f) is on a slant. Each conductive substrate 155 in FIG. 18(d), FIG. 18(e), FIG. 18(h), FIG. 18(i) and FIG. 18(h) has a curved surface. conductive substrate 155 in FIG. 18(e) is a tube which encircles a caterpillar 145, In FIG. 18(e), interaction area between the conductive substrate 155 and the caterpillar 145 is the largest, thus the thrust between the conductive substrate 155 and the caterpillar 145 is the largest. In FIG. 18(i) and FIG. 18(j), the conductive substrates 155 encircle parts of the caterpillars 145. But in FIG. 18(d) and FIG. 18(h), the caterpillar 145 is out of the curved conductive substrate 155.

In various embodiments, a conductive substrate can be a continuous structure, such as substrates in FIG. 18(a) to FIG. 18(f). But in other embodiments, a conductive substrate can be composed of a plurality of separated conductive plate, such as substrates in FIG. 18(g) and FIG. 18(k). Generally, continuous structure can generate stronger eddy currents and thus produce greater thrust, but separated structure has less mass.

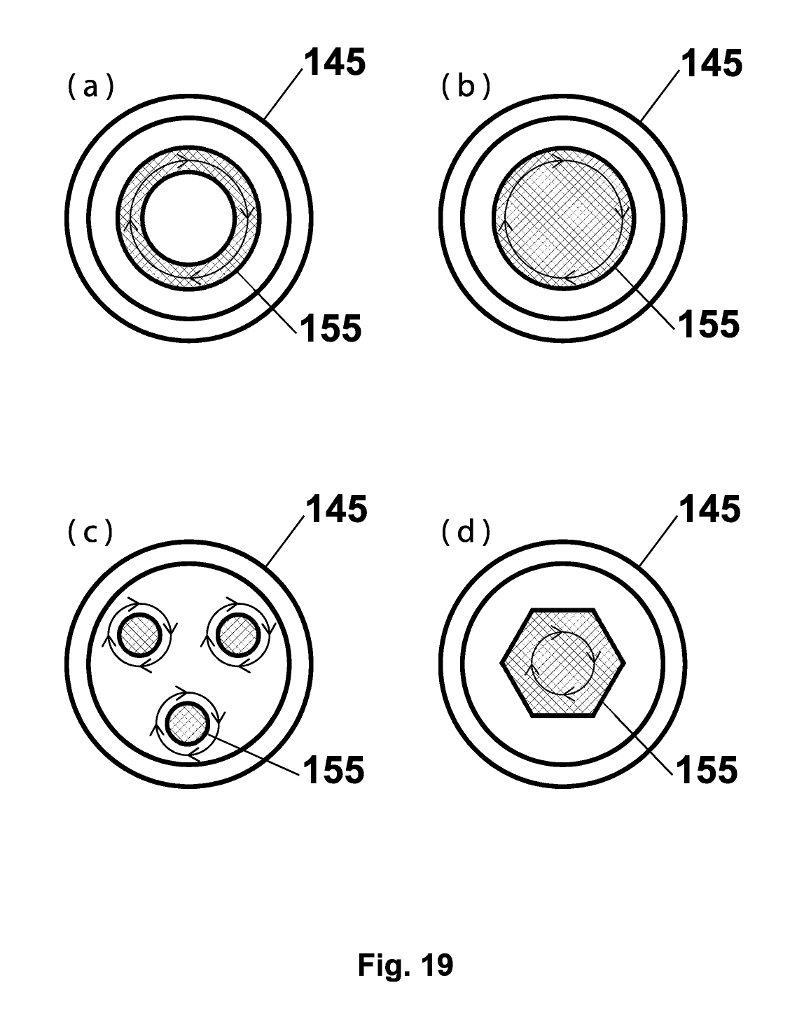

In various embodiments, a caterpillar can be assembled to generate magnetic field inward rather than outward. In order to interact with the magnetic field of a caterpillar, a conductive substrate can be arranged in the caterpillar. FIG. 19 shows examples of various electromechanical systems of this arrangement.

In FIG. 19(a), both a caterpillar 145 and a conductive substrate 155 have tubular structures and the conductive substrate 155 is in the caterpillar 145. The magnets of caterpillar 145 are arranged to generate magnetic field inward, when the caterpillar 145 rotates along is axis, it can generate a magnetic field which changes as function of time. The time varying magnetic field interacts with conductive substrate 155 to form eddy currents. The arrow in FIG. 19(a) denotes the direction of the currents. The eddy currents and their associated magnetic field and the magnetic field from the caterpillar 145 interact to generate force.

In FIG. 19(b), a solid conductive substrate 155 is located in a tubular caterpillar 145. The eddy currents in the solid conductive substrate 155 focus on the surface thereof, thus the eddy currents in FIG. 19(a) is almost equal to the eddy currents in FIG. 19(b), while the conductive substrate 155 in FIG. 19(b) has less mass.

In FIG. 19(c), three separate conductive rod 155 are arranged in a tubular caterpillar 145 to act as conductive substrate. The eddy currents in the conductive rod 155 is less than the eddy currents the conductive substrate 155 in FIG. 19(b).

The shape of the conductive substrate is not necessary to be circular, the conductive substrate can have arbitrary shape, for example, a hexagon pattern in FIG. 19(d).

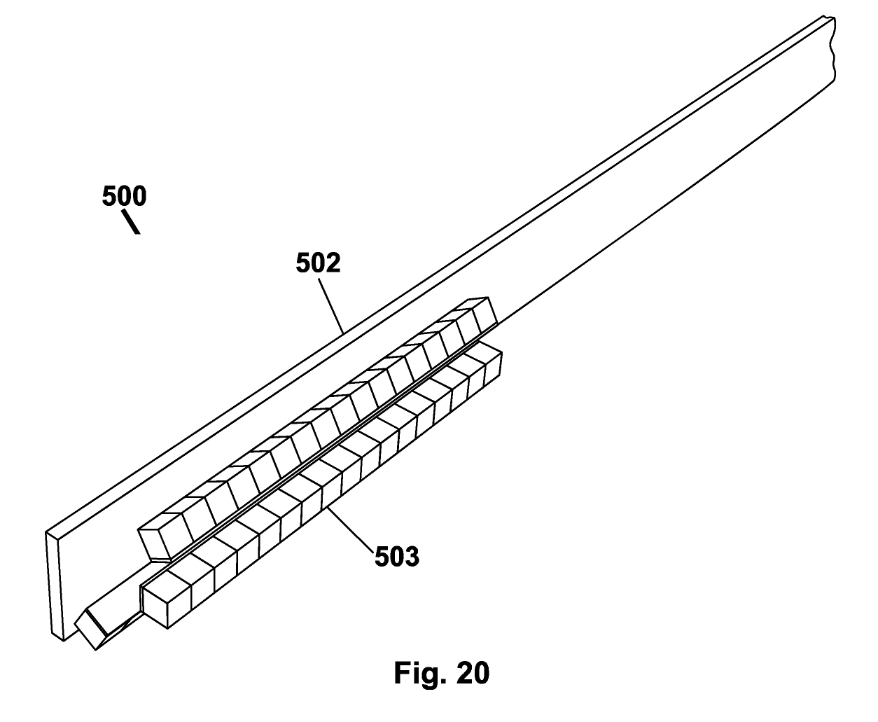

FIG. 20 shows an electromechanical system 500 including a caterpillar 503 and a conductive substrate 502. Rotating the caterpillar 503 round its axis will generate a moving magnetic field with regard to the substrate 502. The eddy currents provide an opposing magnetic field, which generates magnetic lift and thrust to support and drive the caterpillar 503.

Compared with hoverboard described in U.S. Pat. No. 9,325,220, the caterpillar has following characteristics: it is powered by simple mechanical rotation about axis. it is composed as a cylinder of outward facing, linear Halbach-type elements, which vary in the relative linear/axial position of their array elements. The magnetic position is variable. In an embodiment, the physical extent is not. Successive array elements are exchanged by rotation with regard to their position and interaction with the substrate. This exchange of arrays with varying relative magnetic position constitutes a moving magnetic field with regard to the substrate. The exchange of arrays, into and out of working condition in proximity with the substrate, is facilitated by the relatively small diameter of the array. The changing magnetic field approximates an axial scrolling action, above and into the substrate, with regard to the working magnetic fields. It is not intended to approximate a helical or circumferential scrolling action. The axis-of-rotation is horizontal rather than substantially vertical. This configuration may offer control options via variations in RPM rather than by tilting or mechanically changing the axis of rotation relative to substrate. If RPM-based control options can be realized, driveline length does not change and driveline angle is constant, facilitating simple means of power distribution from central locations of single or multiple motors. Array design emulates a translating or oscillating linear Halbach array.

In an embodiment, array design can generate linear thrust, aligned with the major axis (and axis of rotation), which is geometrically neutral with regard to translation along that axis. In an embodiment, array design can generate no linear thrust, only lift, if composed of elements which generate opposed thrust components. Array may be adapted to low and/or higher translation speeds by varying the increment and extent of the elements composing the array. In an embodiment, small diameter can facilitate very high RPM operation due to lower centrifugal forces generated. high RPM operation may take advantage of more common motors designed for high RPM performance. Array can increase in lift or traction as length increases. A long array may be able to replace multiple individual Starm(s)/motor(s). Rotary operation emulates translation and oscillation without changes in moment of inertia. In an embodiment, it can constitute a rotary, virtually incremented by exchange, axially translating, Halbach array.

### Vehicle Configuration Including Caterpillars

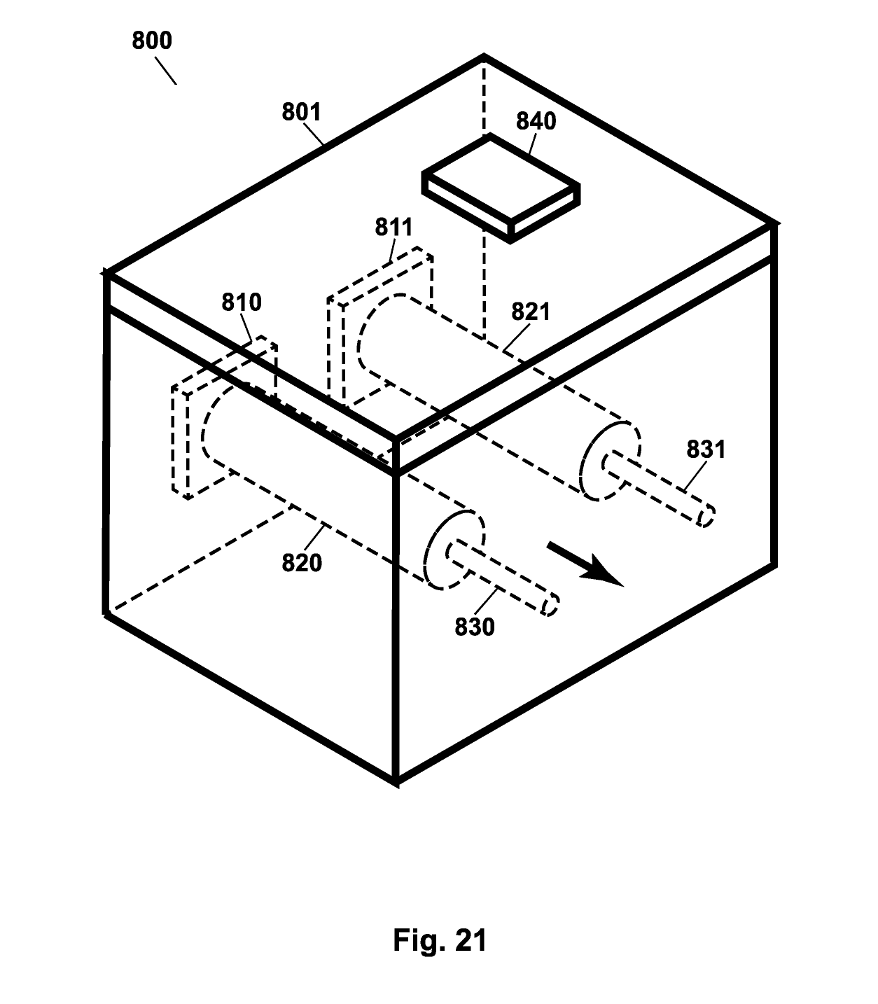

Next, with respected to FIG. 21, various configurations of vehicles including caterpillars are described. In particular, arrangements of caterpillars and then their actuation to provide movement are described.

FIG. 21 shows an illustration of a vehicle 800 configured to operate over a conductive substrate (not shown), the vehicle 800 includes two caterpillars 820, 821 received in a box 801, the box 801 can have four side walls and a top wall. each left end of the caterpillars 820, 821 couples to two motors 810, 811 respectively and can be rotate by the motors 810, 811 along each of their axes. The two motors 810, 811 are fixed on a side wall of a box 801 with their rotation axes being parallel with each other and parallel to the conductive substrate. Each right end the caterpillars 820, 821 coupled to other side wall of the box through shaft 830, 831 and bears (not shown) on the side wall.

The motors associated with each caterpillar can be coupled to one or more speed controllers (not shown) which respond to commands from a master controller 840. The controllers and the motors can also be coupled to a power source (not shown). The one or more speed controllers can be mechanical speed controller or electronic speed controllers. The power source can be on-board or off-board. The master controller 840 can comprise an inertial measurement unit (IMU) (not shown). An IMU works by detecting the current rate of acceleration using one or more accelerometers to determine changes in position. A processor in master controller 840 can continually calculate the vehicle's current position and current velocity.

In operation, the master controller 840 commands speed controllers to operate the motors 810, 811, such that the caterpillars rotate above a conductive substrate. According to the patterns of the caterpillars 820, 821, the vehicle can have different movement. For example, if the caterpillars are Bidirectional/Reversible, induce eddy currents in the conductive substrate interact with the magnet fields of the caterpillars 820, 821, and if net axial thrust is equal to zero, the vehicle would be lifted to suspend above the conductive substrate and stand still. If the caterpillars 820, 821 are unidirectional, induce eddy currents in the conductive substrate interact with the magnet fields of the caterpillars 820, 821, lifting the vehicle and driving the vehicle move from left to right or right to left along the axes of the caterpillars 820, 821 if the two caterpillars 820, 821 are identical and the rotation speeds of the motors 810, 811 are identical. if the two caterpillars 820, 821 are different or the rotation speeds of the motors 810, 811 are different, the thrusts on the two caterpillars 820, 821 are different which makes the vehicle moves along a helical line.

The vehicle can also oscillate, if the caterpillars are arranged to produce oscillation as above described.

In an embodiment, the box 801 receives other two caterpillars parallel to the conductive substrate, and the axes of the other two caterpillars perpendicular to the two caterpillars 820, 821, each of them can be rotate by a motor controlled by a speed controller. the master controller 840 can commands these speed controllers to operate the motors and drive the caterpillars move along Y-axis. Therefore, the vehicle can move along X-axis or Y-axis in a plane.

The constructions and arrangements of the vehicle described above are provided for the purpose of illustration only. a vehicle can have various constructions. potential embodiments include but are not limited to as fellows. In an embodiment, a vehicle use two to four high RPM motors for power. In an embodiment, a vehicle use four opposed caterpillars and RPM variation for control and propulsion with no linkages or pivots. In an embodiment, a hoverboard comprises one high RPM motor to drive two bidirectional steering/carving caterpillars and one high RPM motor to drive two bidirectional lift/propulsion/braking caterpillars. In an embodiment, a caterpillar is below conveyor path to eject desirable or undesirable materials such as non-ferrous metals or ores. In an embodiment, caterpillar is below conveyor path or material path to hover and transport with passive centering function. In an embodiment, caterpillars are in parallel to allow for levitation and translation of rod or bar stock of nonferrous or hoverable materials. In an embodiment, low profile installations of hover engines can be formed by caterpillars and low profile power distribution and transmission is operated by belts. Due to Readily implemented low profile RPM gearing between motor and caterpillar, a caterpillar can be used in such situations as high speed translation and/or propulsion; right-angle and off-angle non-touch gearing and coupling; non-touch gear reduction; X: Y movement and rotation of materials in non-touch conveying or positioning; linear or lateral agitation of conveyors, tanks, materials, or structures; variable agitation frequency or magnitude, based on displacement, of conveyors, tanks, materials, or structures and so on.

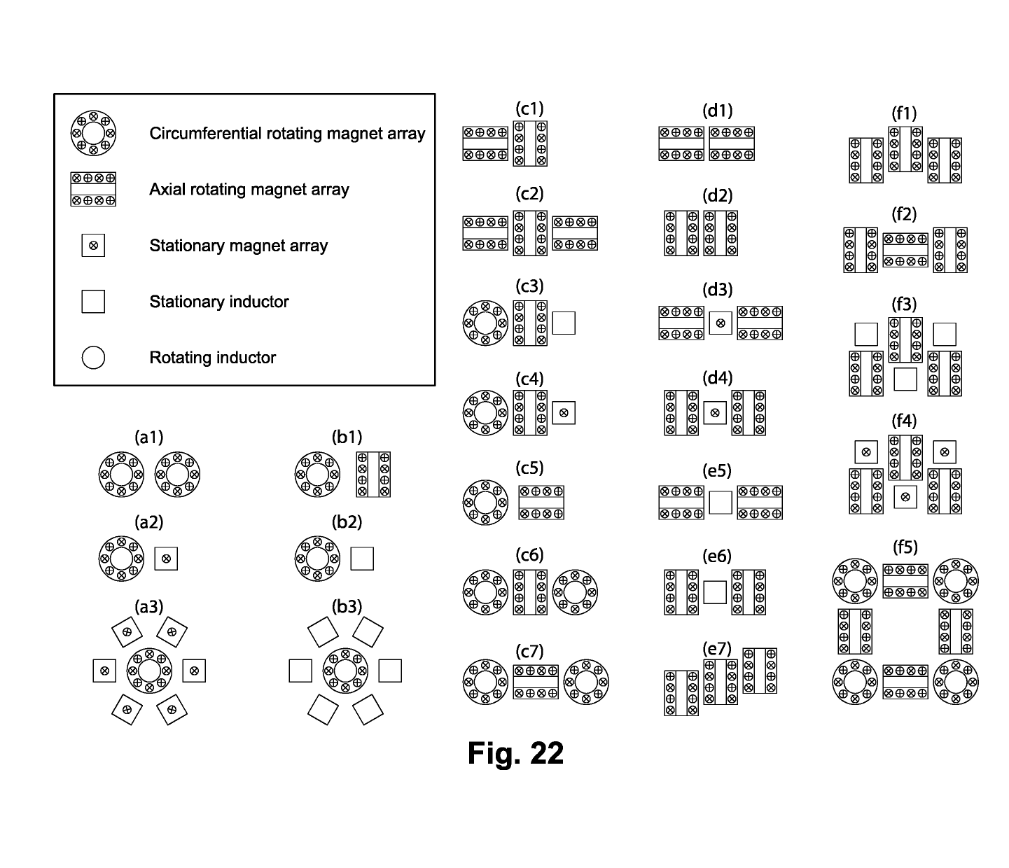

In other embodiments, various caterpillars can be assembled in electromechanical systems to generate relative movement. FIG. 2 2 shows embodiments of various electromechanical systems which can generate relative movement. For example, FIG. 22(a1) shows two parallel circumferential rotating magnet array, each can generates travelling magnetic field, if the two travelling magnetic fields is relatively moveable, the two travelling magnetic fields can make them to move relatively along the direction of the travelling magnetic field, just like synchronous linear motor. FIG. 22(a2) shows a circumferential rotating magnet array and a stationary magnet array, the axis of the circumferential rotating magnet array is parallel to the stationary magnet array, a travelling magnetic field generated by the circumferential rotating magnet array moves relatively to the stationary magnetic field generated by the stationary magnet array. The relatively movement of the two magnetic fields make them to move relatively along the direction of the travelling magnetic field. Therefore, generating lift and thrust is not limited to assemblies of caterpillar and conductive substrate. Caterpillars which can produce mutual movement magnetic field can generate lift and thrust. Caterpillar and stationary magnet array which can produce mutual movement magnetic field can also generate lift and thrust.

The main improvement of the present invention is to close a halbach array into a circle enabling all the other advances our Hover Engines have demonstrated i.e. stationary hover, omnidirectional movement, propulsion, control, braking, etc.

### Magnet Array Based on Rotating Individual Magnets

Next, magnet array based on rotating individual magnets about an axis perpendicular to the magnetization direction through the centroid of each magnet, is described.

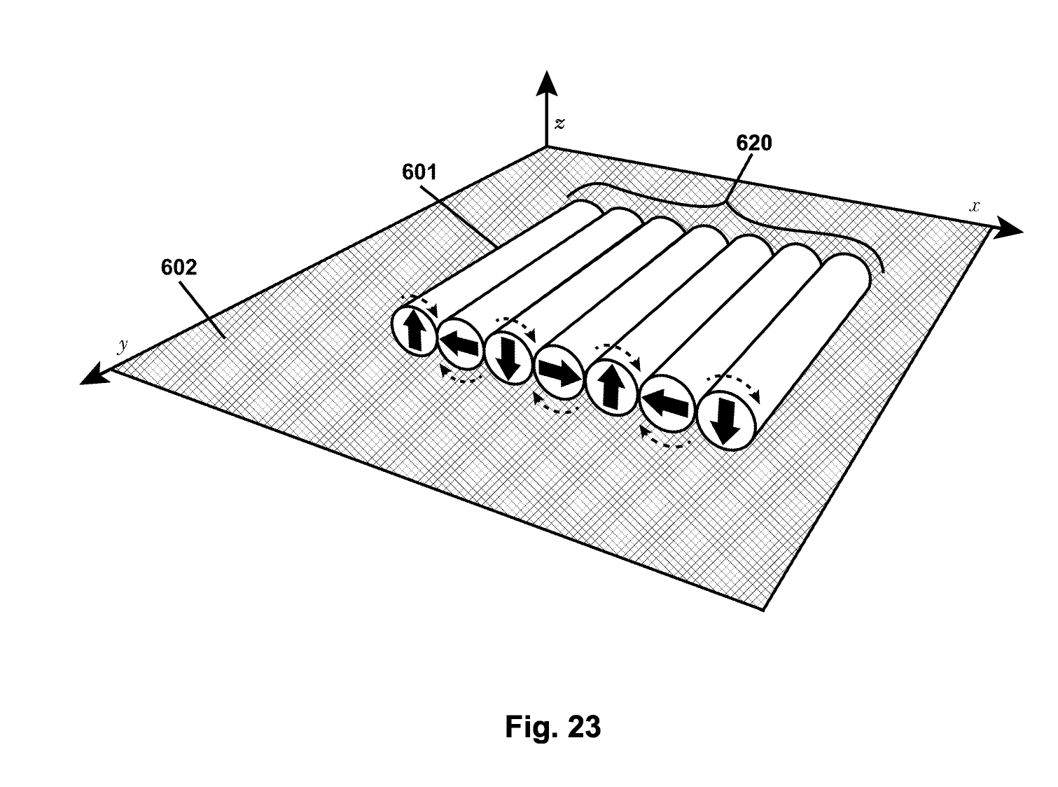

Referring to FIG. 23, seven bar magnets 601 are arranged parallel to each other to form a rectangular magnet array 620, and the rectangular magnet array 620 is parallel to a conductive substrate 602. Each of the bar magnets 601 can be rotated by a motor (not shown) along its axis. at time T1, the magnetization orientation of each piece's magnetic field in the seven bar magnets 601 is upward, leftward, downward, rightward, upward, leftward and downward respectively from left end to right end of the array.

FIG. 24 is a front view of the magnet array 620, magnetic field distribution of magnet array 620 along the X-axis is an approximately sinusoidal waveform, the wavelength of the sinusoidal waveform is λ which corresponds to the sum of length of the magnets in a period. The direction of the magnetic field is approximately parallel to the Z-axis and the magnetic field intensities are almost equal along the Y-axis.

From time T1 to time T2, rotating each of the bar magnets 601 along respective axis counter clockwise by 90 degrees, the magnetization orientation of each piece's magnetic field in the seven bar magnets 601 is leftward, downward, rightward, upward, leftward, downward and rightward respectively from left end to right end of the array.

At time T2, magnetic field distribution of magnet array 620 along the X-axis is also an approximately sinusoidal waveform, the effect to the distribution of magnetic field above the conductive plate is that the sinusoidal waveform 701 at time T1 is substituted by sinusoidal waveform 702 at time T2, because sinusoidal waveform 701 and sinusoidal waveform 702 have the same wave shape, only have a distance of ¼ λ of the sinusoidal waveform along X-axis, which is equivalent to that the sinusoidal waveform 701 travels a distance of ¼ λ of the sinusoidal waveform from right to left along X-axis. Similarly, continuously rotating each of the bar magnets 601 counter clockwise at the same angular speed, the magnet array 620 will generate a continuously moving sinusoidal waveform from right to left along X-axis over the conductive plate 602, the continuously moving sinusoidal waveform is a kind of travelling electromagnetic wave.

In operation, when continuously rotating each of the bar magnets 601 clockwise at the same angular speed, the magnet array 620 will generate a travelling electromagnetic wave moving from left to right along X-axis over the conductive plate.

The magnet array 620 is similar to a rotor of a linear induction motor and the conductive plate 602 is similar to a rotor of the linear induction motor, the travelling electromagnetic wave between the magnet array 620 and the conductive plate 602 can induce eddy currents in the conductive plate and generates forces to lift the magnet array 620 and thrust it to move along the travelling electromagnetic wave over the conductive plate 602. the translation speed of the magnet array 620 is nearly but slightly less than the speed of the travelling electromagnetic wave.

Similar to FIG. 7, because angles of magnetization orientation of adjacent magnets (also named phase angles between adjacent magnets) in the magnet array 620 are 90 degrees, the wavelength λ is the sum of length of the four magnets. Decreasing the angles of the orientation of adjacent magnets in the magnet array 620, the wavelength λ will increase. for example, if the phase angles are 60 degrees, wavelength is the sum of length of six magnets. if the phase angles are 45 degrees, the wavelength is the sum of length of eight magnets.

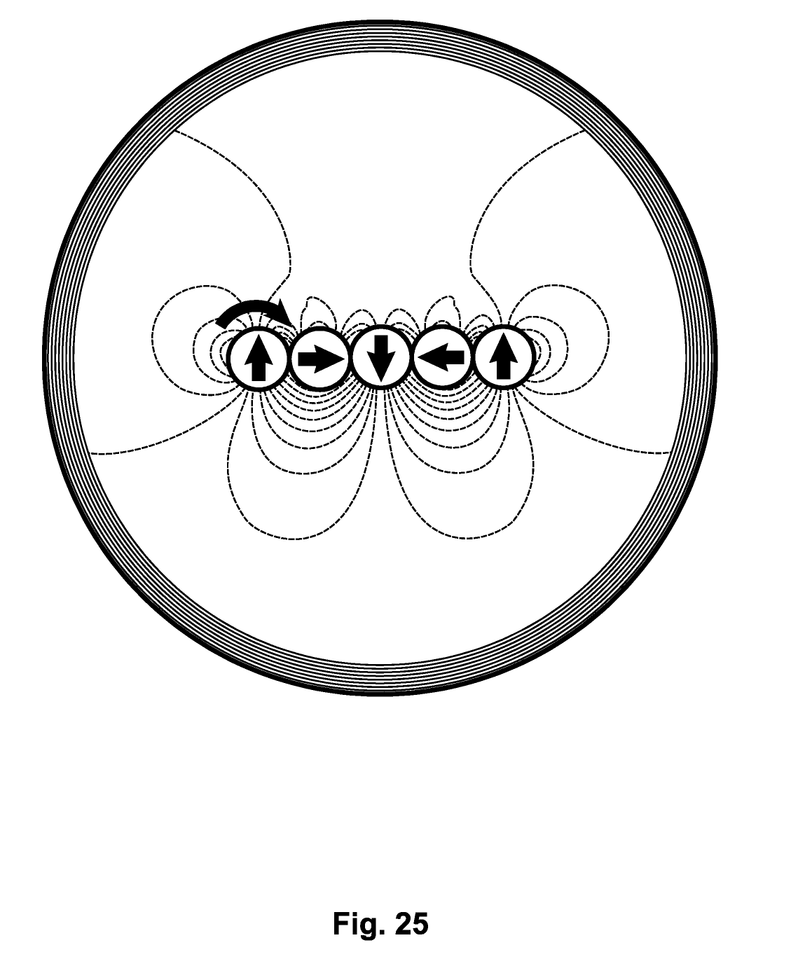

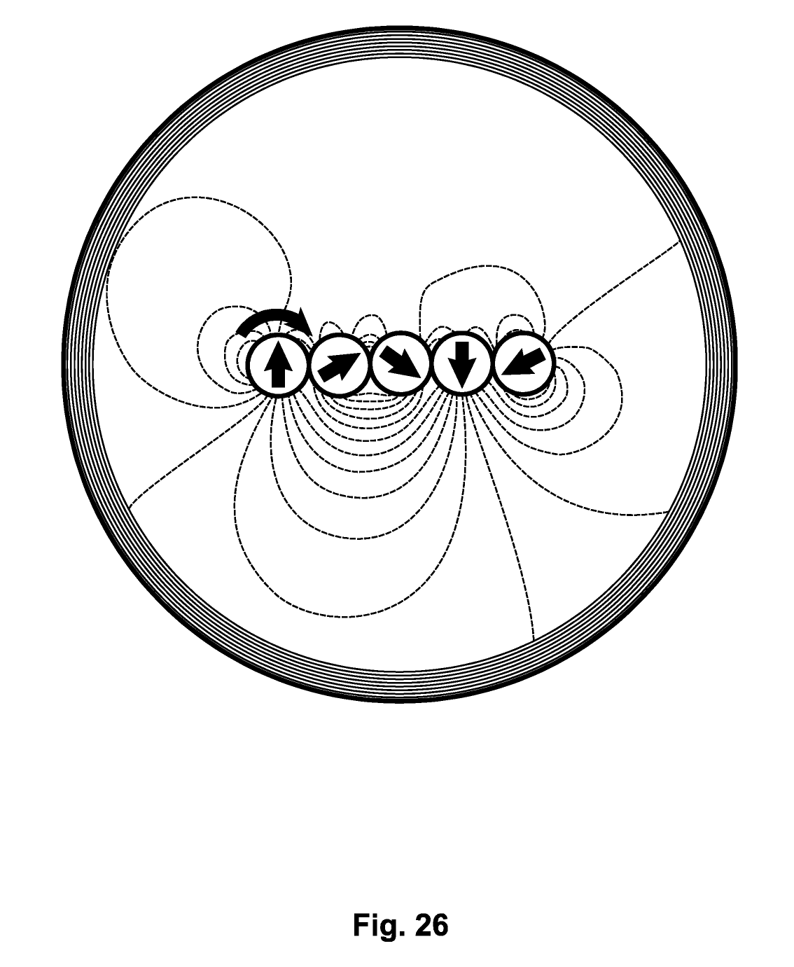

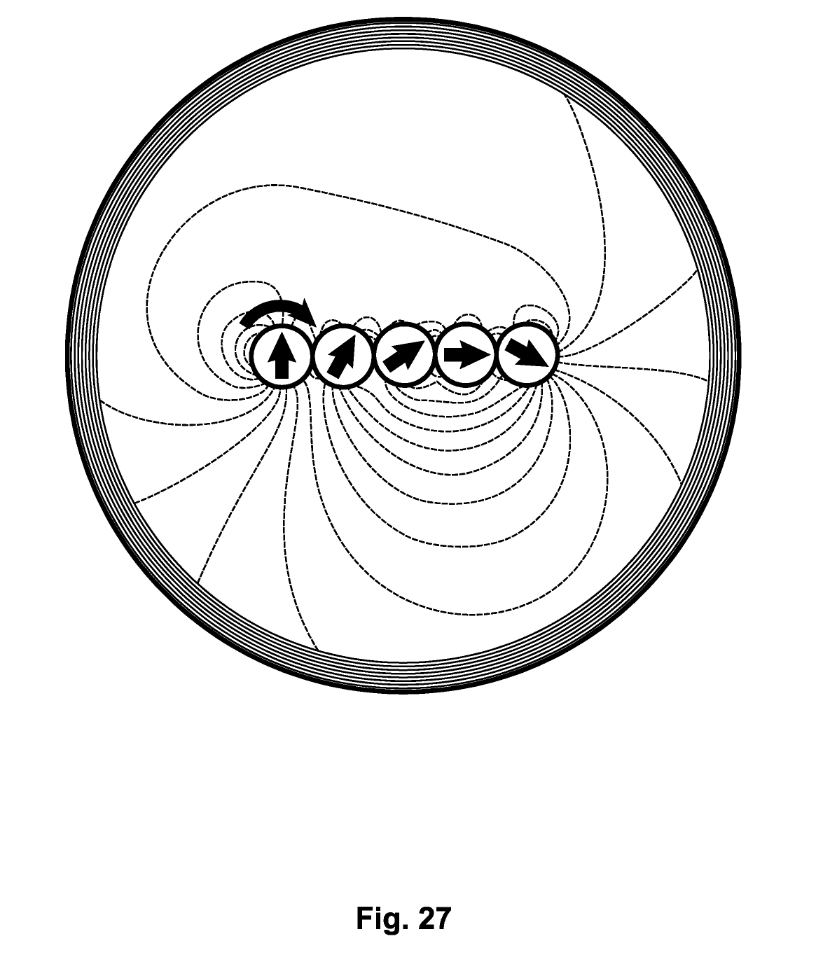

FIG. 25, FIG. 26, and FIG. 27 show magnetic field distribution of magnet arrays which have different angles of magnetization orientation of adjacent magnets, Finite element analysis tool (Femm) to solve Maxwell's equation was used. In FIG. 25, phase angles between adjacent magnets are 90 degrees, the wavelength λ is the sum of length of the four magnets. In FIG. 26, phase angles between adjacent magnets are 60 degrees, the wavelength λ is the sum of length of six magnets. In FIG. 27, phase angles between adjacent magnets are 30 degrees, the wavelength λ is the sum of length of twelve magnets. When each of the bar magnets in FIG. 25, FIG. 26, and FIG. 27 rotates counter clockwise by one revolution, travelling electromagnetic waves generated by bar magnets in FIG. 25, FIG. 26, and FIG. 27 moving from left to right along X-axis over the conductive plate by distances of their respective one wavelength. That is, in FIG. 25, the travelling electromagnetic wave moves a distance of a sum of length of 4 magnets, in FIG. 26, the travelling electromagnetic wave moves a distance of a sum of length of six magnets, and in FIG. 27, the travelling electromagnetic wave moves a distance of a sum of length of twelve magnets. Therefore, Varying the phase angles between adjacent magnets changes the effective wavelength of array, in turn changing the effective velocity of the travelling electromagnetic wave above and below the array. Varying rotation speed of the magnets can also change the effective velocity of the travelling electromagnetic wave above and below the array, such that the translation speed of a magnet array can be changed by varying phase angles between adjacent magnets of the magnet array or by varying rotation speed of each magnets of the magnet array.

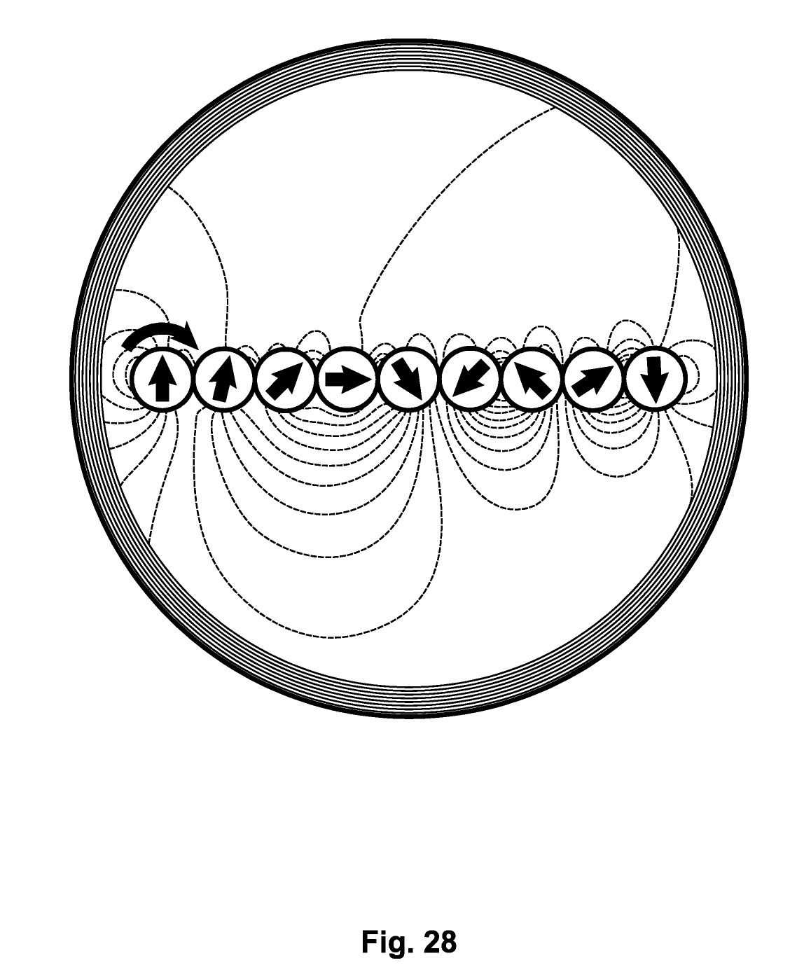

Different phase angles can be used to create Halbach arrays which can be switched both above and below the array through alternating N-S poles, or any other arbitrary pattern. Patterns do not need to be regular and can vary as a function of position on the array, for example a continuously variable wavelength Halbach arrays which has short wavelength on one end, long wavelength on the other end. FIG. 28 shows a magnetic field distribution of magnet arrays which have patterns varying as a function of position on the arrays. In FIG. 28, phase angle increases from left to right, with a corresponding decrease in wavelength. Since the magnets rotate clockwise at the same rate, the pole on the underside of the array progress to the left, increasing in speed from right to left. In another configuration, the rotational speed of each magnet may also be changed independently.

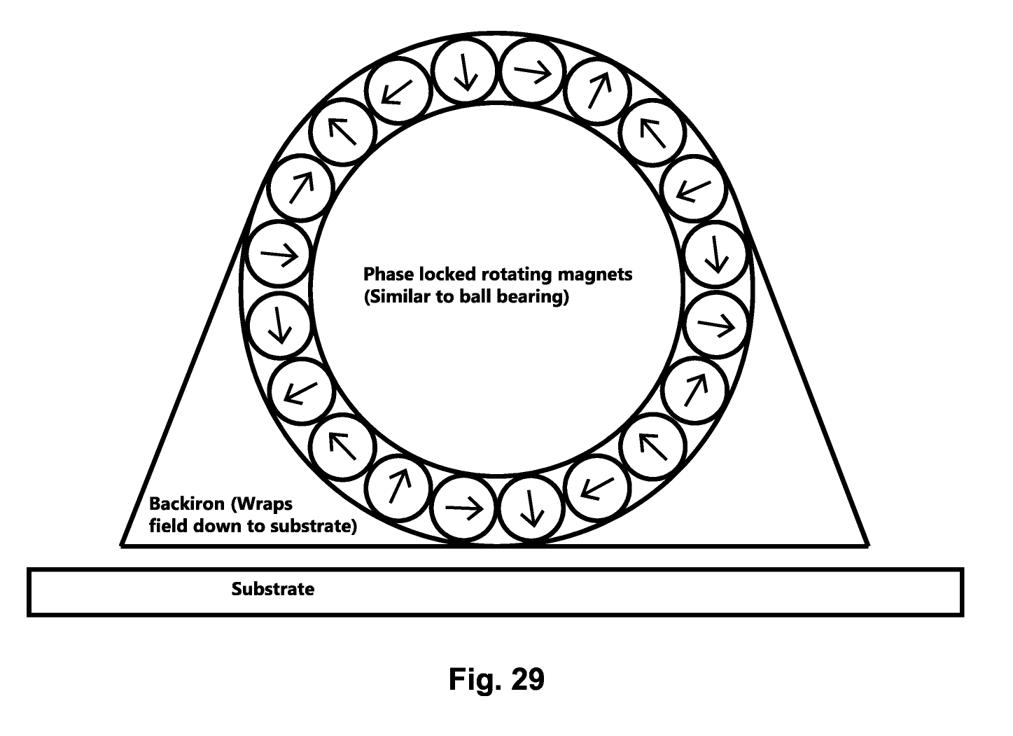

In operation, rotating magnets of the magnet arrays can be driven independently or in groups. Upon driven independently, each of the magnet connect with a motor while driven in groups, a plurality of magnets can be connected by a transmission mechanism coupled to a motor. In one embodiment, multiple 1D arrays may be combined to create 2D arrays, with shared or independent drive motors. In one embodiment, 1D arrays may be wrapped in a planetary gear configuration to facilitate motor driving, conducting the flux to the intended surface through ferrous core pieces. FIG. 29 shows a planetary gear configuration in which phase locked rotating magnets (similar to ball bearing) and a backiron (wraps field down to substrate), and a substrate. In one embodiment, permanent magnets are used. In one embodiment, electromagnets are used. And in one embodiment, electromagnets are used instead of permanent magnets.

Unlike a caterpillar, magnet array based on rotating individual magnets has following characteristics: Rotating individual magnets instead of entire arrays, variable speed through rotation rate and phase angle, Dynamic magnet array due to variable phase angle of magnets.

Similar to the caterpillars, one or a plurality of magnet arrays based on rotating individual magnets can be arranged in a vehicle, interacting with a conductive substrate to drive the vehicle to suspend and move over the conductive substrate.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. A circumferential array of magnet elements, wherein the magnetic fields generated by the magnet elements varies in at least one of the relative linear, axial, position, or phase.

2. The circumferential array of claim 1, wherein when the circumferential array rotates round its axis, it generates a travelling magnetic field moving along its axis.

3. The circumferential array of claim 2, wherein direction angles on different position of the circumferential array are the same.

4. The circumferential array of claim 2, wherein direction angles on different position of the circumferential array are different.

5. The circumferential array of claim 4, wherein direction angles along the axis of the circumferential array are different.

6. The circumferential array of claim 5, wherein direction angles in one or a plurality of sections along the axis of the circumferential array are less than 90 degrees, direction angles in other one or a plurality of sections along the axis of the circumferential array are larger than 90 degrees.

7. The circumferential array of claim 4, wherein direction angles along the circumferential direction of the circumferential array are different.

8. The circumferential array of claim 7, wherein direction angles in one or a plurality of sections along the circumferential direction of the circumferential array are less than 90 degrees, direction angles in other one or a plurality of sections along the circumferential direction of the circumferential array are larger than 90 degrees.

9. The circumferential array of claim 2, wherein the circumferential array comprises one or a plurality of linear Halbach array.

10. The circumferential array of claim 2, wherein the speed of the travelling magnetic field can be adapted by varying the phase increment of the circumferential array.

11. The circumferential array of claim 2, wherein the speed of the travelling magnetic field can be adapted by varying the wavelength of the travelling magnetic field.

12. An electromechanical system comprising a conductive substrate and a circumferential array of claim 1, wherein rotating the circumferential array round its axis will generate a travelling magnetic field over the conductive substrate.

13. The electromechanical system of claim 12, further comprising a variable RPM motor coupled with the circumferential array to rotate the circumferential array round its axis.

14. The electromechanical system of claim 12, wherein the axis of the circumferential array is parallel the conductive substrate.

15. The electromechanical system of claim 14, wherein the travelling magnetic field over the conductive substrate induces eddy currents in the conductive substrate, the eddy currents provide an opposing magnetic field to generate magnetic lift and thrust to support and drive the circumferential array.

16. The electromechanical system of claim 14, wherein the thrust is unidirectional along the axis.

17. The electromechanical system of claim 14, wherein the thrust is bidirectional along the axis, directions of thrust in one or a plurality of sections along the axis of the circumferential array are forward directions, directions of thrust in other one or a plurality of sections along the axis of the circumferential array are backward directions.

18. The electromechanical system of claim 14, wherein the thrust make the circumferential array oscillate along the along the axis of the circumferential array; wherein directions of thrust in one or a plurality of sections along the circumferential direction of the circumferential array are forward directions, directions of thrust in other one or a plurality of sections along the circumferential direction of the circumferential array are backward directions.

19. A vehicle, comprising a conductive substrate and a plurality of circumferential arrays of claim 1, wherein rotating the circumferential array round its axis will generate a travelling magnetic field over the conductive substrate.

20. A vehicle of claim 19, further comprising one or a plurality of motors to rotate the circumferential arrays.

21. A vehicle of claim 20, wherein the control of the vehicle is performed by control the rotation speeds and directions of the motors.

22. A magnet array comprising a plurality of magnets which can be rotated about axis perpendicular to the magnetization direction through the centroid of each magnet.

23. A magnet array of claim 22, wherein the rotation about axis perpendicular to the magnetization direction through the centroid of each magnet generates a travelling magnetic field moving along its axis.

24. An electromechanical system comprising a conductive substrate and a circumferential array of claim 22, wherein the rotation about axis perpendicular to the magnetization direction through the centroid of each magnet generates a travelling magnetic field over the conductive substrate.

25. An electromechanical system comprising a conductive substrate and a circumferential array of claim 23, wherein the rotation about axis perpendicular to the magnetization direction through the centroid of each magnet generates a travelling magnetic field over the conductive substrate.

26. An electromechanical system of claim 24, wherein the circumferential array is parallel to the conductive substrate.
